(19) United States
(12) Patent Application Publication
(10) Pub. No.: US 2026/0203868 A1
(43) Pub. Date: Jul. 16, 2026

(54) DENOISING PATH-TRACED IMAGES USING TRANSFORMER NETWORKS

(71) Applicant: NVIDIA Corporation, Santa Clara, CA (US)

(72) Inventors: Pekka Markus JÄNIS, Espoo (FI); Shiqiu LIU, Santa Clara, CA (US); James Matthew NORTON, San Jose, CA (US); Karthik VAIDYANATHAN, Oakland, CA (US); David TARJAN, Mountain View, CA (US); Juho MARTTILA, Espoo (FI); Pietari Armas KASKELA, Helsinki (FI)

(73) Assignee: NVIDIA Corporation, Santa Clara, CA (US)

(21) Appl. No.: 19/020,708

(22) Filed: Jan. 14, 2025

(51) Int. Cl. G06T 5/60; G06T 5/70; G06T 15/06

(52) U.S. Cl. CPC G06T 5/60; G06T 5/70; G06T 15/06; G06T 2207/20021; G06T 2207/20081; G06T 2207/20084

(57) ABSTRACT

In various examples, one or more processors can include one or more circuits to obtain image data for a current image being generated, in accordance with one or more ray tracing operations. The image data can correspond to a current image prior to or during reconstruction of that image. The image can be grainy, include artifacts, etc. To reduce these affects, the one or more circuits can execute one or more attention operations to determine an update to the current image based at least on a plurality of patches of the current image and windowed attention regions corresponding to each patch of the plurality of patches. In some examples, the windowed attention regions can extend at least in part beyond boundaries of each patch, allowing for information from neighboring patches to be used to update the image when reconstructing the image.

### BACKGROUND

Light transport simulation techniques such as path tracing, ray tracing, full ray tracing, etc., are increasingly being applied across a variety of use cases, allowing video game studios, animation studios, architecture and graphic design firms, etc., to generate higher fidelity and almost “life-like” image of scenes. However, due to the computational demands involved in tracing light paths through a scene, it can be extremely difficult to implement these techniques while maintaining image fidelity, particularly for real-time or near real-time applications. For example, as the number of rays to be traced and sampled increases, it can be difficult for devices involved in real-time image generation (e.g., devices with a fixed number of GPUs/CPUs and memory) to continuously operate at a set rate. As a result, depending on the computational constraints of the devices involved, budgets can be imposed on the number of rays to be traced and sampled for each pixel. This can allow for faster image generation and avoid performance issues during the image generation process, but result in extremely noisy images as computing constraints increase.

Some techniques for addressing these problems involve implementing real-time denoisers that re-use spatial and temporal information across multiple samples for a given pixel to determine the final pixel color in the output image. And more recently, techniques such as Deep Learning Super Sampling (DLSS) Ray Reconstruction have been developed to implement these spatial filters and predict temporal filter coefficients. While these techniques have shown substantial improvements in overall noise reduction and image fidelity, current implementations involving the use of convolutional neural networks (CNNs) can result in the introduction of undesirable artifacts (e.g., blurred detail in shadows and reflections, temporal instability and Moiré patterns, smudges, ghosting, etc.) in the output images.

### SUMMARY

Embodiments of the present disclosure relate to noise reduction in computer generated images. For example, systems and methods are disclosed that allow for noise reduction in computer-generated images in real-time to improve image fidelity when using resource-constrained computing devices, systems, or platforms.

The present disclosure addresses the above-noted difficulties and describes an implementation involving the configuration of multiple transformers in a larger model to form contracting and expansion paths that implement spatial and temporal filters at varying resolutions. Specifically, systems are described as being configured to: (1) obtain image data for an image generated in accordance with one or more ray (or path) tracing operations, (2) execute attention operations using multiple transformers to determine updates to the image where the attention operations are based at least on windowed attention regions corresponding to one or more (e.g., each) patches of an image, and (3) provide the updated image data to cause (e.g., complete) generation of the current image. The windowed attention regions can extend at least in part beyond boundaries of a patch and can also be offset vertically and horizontally (e.g., at successive stage(s) of contraction/expansion) to further reduce noise within the image.

In contrast to conventional systems, the techniques described herein allow for significant reductions in noise as compared to other de-noising techniques that can, in some cases, introduce noise into ray traced images. Further, with certain windowed attention region configurations, data can be kept locally (e.g., in registers of a given processing element), thereby reducing or eliminating calls to memory that would require additional computation cycles. This both reduces the consumption of computing resources when de-noising a given image while also increasing the speed at which images can be de-noised. Depending on the implementation, lower floating point precision can also be implemented, allowing for higher throughput by the underlying tensor cores.

At least one aspect relates to one or more processors. The one or more processors can include one or more circuits to obtain image data for a current image being generated, in accordance with one or more ray tracing operations; execute one or more attention operations to determine an update to the current image based at least on a plurality of patches of the current image and windowed attention regions corresponding to at least one patch of the plurality of patches, the windowed attention regions extending at least in part beyond boundaries of each of the at least one patch; and provide updated image data according to the update, to generate the current image.

In some implementations, the one or more circuits can determine a configuration for the windowed attention regions that, for at least one patch, identifies tokens of the patch and one or more adjacent patches. In some implementations, to execute the one or more attention operations, the one or more circuits are to, for each of the at least one patch, execute the one or more attention operations based at least on the tokens. In some implementations, the one or more circuits that determine the configuration for the windowed attention regions are to determine sub-regions for the windowed attention regions that extend across at least one horizontally adjacent patch or at least one vertically adjacent patch. In some implementations, the one or more circuits that determine the configuration for the windowed attention regions are to forgo determining sub-regions for the windowed attention regions that extend across at least one diagonally adjacent patch.

In some implementations, the one or more circuits can determine an offset to the windowed attention region for at least one patch. The offset can indicate a vertical offset or a horizontal offset of the windowed attention region relative to each of the at least one patch. In some implementations, the one or more circuits that perform the operation of to execute one or more attention operations are to apply the offset to the windowed attention region for each of the at least one patch, and execute the one or more attention operations based at least on applying the offset. In some implementations, the plurality of patches of the current image can include a first plurality of patches. In some implementations, the one or more circuits that execute the one or more attention operations are to: execute a first transformer along a contraction path of an attention-based model based at least on first patch embeddings for the first plurality of patches to generate updated first patch embeddings; merge the updated first patch embeddings to form second patch embeddings; and execute a second transformer along the contraction path based at least on the second patch embeddings. In implementations, to execute the first transformer along the contraction path, the one or more circuits can determine at least one first threshold value associated with the execution of the one or more attention operations; and generate the updated first patch embeddings based at least on the at least one first threshold value.

In some implementations, the one or more circuits that execute the one or more attention operations are to: execute a first transformer along an expansion path of the attention-based model based at least on the second patch embeddings to generate updated second patch embeddings; expand the updated second patch embeddings to form third patch embeddings; and execute a second transformer along the expansion path. The second transformer can be executed based at least on the third patch embeddings. In implementations, to execute the first transformer along the expansion path, the one or more circuits can determine at least one second threshold value associated with the execution of the one or more attention operations; and generate the updated first patch embeddings based at least on the at least one second threshold value.

In some implementations, the one or more circuits that execute the first transformer and the second transformer along the contraction path are to: execute the first transformer based at least on a first windowed attention region and a first offset, and execute the second transformer based at least on a second windowed attention region and a second offset. In some implementations, the one or more circuits that execute the first transformer and the second transformer along the expansion path are to: execute the first transformer based at least on a first windowed attention region and a first offset and execute the second transformer based at least on a second windowed attention region and a second offset.

At least one aspect relates to a system. The system can include one or more processors to perform operations. In some implementations, the operations include obtaining image data for a current image being generated, in accordance with one or more ray tracing operations and executing one or more attention operations to determine an update to the current image based at least on a plurality of patches of the current image and windowed attention regions corresponding to at least one patch of the plurality of patches. The windowed attention regions can extend at least in part beyond boundaries of each of the at least one patch. In some implementations the one or more processors are to perform the operation of providing updated image data according to the update, to generate the current image.

In some implementations, the one or more processors can perform the operation of determining a configuration for the windowed attention regions that, for each of the at least one patch, identifies tokens of the patch and one or more adjacent patches. In some embodiments, the one or more processors that execute the one or more attention operations are to, for each of the at least one patch, execute the one or more attention operations based at least on the tokens.

In some implementations, the one or more processors that perform the operation of determining the configuration for the windowed attention regions are to perform the operation of: determining sub-regions for the windowed attention regions that extend across at least one horizontally adjacent patch or at least one vertically adjacent patch. In some implementations, the one or more processors that perform the operation of determining the configuration for the windowed attention regions are to perform the operation of: forgo determining sub-regions for the windowed attention regions that extend across at least one diagonally adjacent patch.

In some implementations, the one or more processors can perform the operation of: determining an offset to the windowed attention region for each of the at least one patch. The offset can indicate a vertical offset or a horizontal offset of the windowed attention region relative to each of the at least one patch. In some implementations, the one or more processors that perform the operation of executing one or more attention operations are to perform the operation of: applying the offset to the windowed attention region for each patch of the at least one patch and executing the one or more attention operations based at least on applying the offset.

In some implementations, the plurality of patches of the current image can include a first plurality of patches. In some implementations, the one or more processors that perform the operation of executing the one or more attention operations are to perform the operation of: executing a first transformer along a contraction path of an attention-based model based at least on first patch embeddings for the first plurality of patches to generate updated first patch embeddings, merging the updated first patch embeddings to form second patch embeddings; and executing a second transformer along the contraction path based at least on the second patch embeddings.

In some implementations, the one or more processors that perform the operation of executing the one or more attention operations are to perform the operation of: executing a first transformer along an expansion path of the attention-based model based at least on the second patch embeddings to generate updated second patch embeddings; expanding the updated second patch embeddings to form third patch embeddings; and executing a second transformer along the expansion path. The expansion path can be based at least on the third patch embeddings.

In some implementations, the one or more processors that perform the operation of executing the first transformer and the second transformer along the contraction path are to perform the operation of: executing the first transformer based at least on a first windowed attention region and a first offset and executing the second transformer. The second transformer can be executed based at least on a second windowed attention region and a second offset.

At least one aspect relates to a method. The method can include obtaining image data for a current image being generated, in accordance with one or more ray tracing operations. The method can include executing one or more attention operations to determine an update to the current image based at least on a plurality of patches of the current image and windowed attention regions corresponding to each patch of the plurality of patches. The windowed attention regions can extend at least in part beyond boundaries of each patch. The method can include providing updated image data according to the update, to generate the current image.

In some implementations, the system or the one or more processors is comprised of, or the method is implemented using, at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more multi-model language models; a system implementing one or more large language models (LLMs); a system implementing one or more small language models (SLMs); a system implementing one or more vision language models (VLMs); a system for generating synthetic data; a system for generating synthetic data using AI; a system incorporating one or more virtual machines (VMs); a system implemented at least partially in a data center; or a system implemented at least partially using cloud computing resources.

### BRIEF DESCRIPTION OF THE DRAWINGS

The present systems and methods for noise reduction in computer generated images are described in detail below with reference to the attached drawing figures, wherein:

FIG. 1 is an example environment in which one or more devices operate to reduce noise when generating computer generated images, in accordance with some embodiments of the present disclosure;

FIGS. 2A and 2B are an example model architecture, in accordance with some embodiments of the present disclosure;

FIG. 2C is an example transformer module, in accordance with some embodiments of the present disclosure;

FIG. 2D is an example bottleneck block between encoder blocks and decoder blocks, in accordance with some embodiments of the present disclosure;

FIG. 3 is an example windowed attention region, in accordance with some embodiments of the present disclosure;

FIGS. 4A and 4B are examples of windowed attention region offsets for successive frames, in accordance with some embodiments of the present disclosure;

FIG. 5 is an example of windowed attention region offsets, in accordance with some embodiments of the present disclosure;

FIG. 6 is a flow diagram of a process for reducing noise when generating computer generated images, in accordance with some embodiments of the present disclosure;

FIG. 7A is a block diagram of an example generative language model system suitable for use in implementing some embodiments of the present disclosure;

FIG. 7B is a block diagram of an example generative language model that includes a transformer encoder-decoder suitable for use in implementing some embodiments of the present disclosure;

FIG. 7C is a block diagram of an example generative language model that includes a decoder-only transformer architecture suitable for use in implementing some embodiments of the present disclosure;

FIG. 8 is a block diagram of an example computing device suitable for use in implementing some embodiments of the present disclosure; and

FIG. 9 is a block diagram of an example data center suitable for use in implementing some embodiments of the present disclosure.

### DETAILED DESCRIPTION

Systems and methods are disclosed related to reducing noise when generating computer generated images. For example, systems described herein can include one or more processors that include one or more circuits configured to obtain image data for an image being generated (e.g., a “current image”). The current image can be in the process of being generated by a computing device in accordance with one or more ray (or path) tracing operations. The system can then execute one or more attention operations to determine an update to the current image. This update can be based at least on a plurality of patches of the current image and windowed attention regions corresponding to each patch of the plurality of patches. As described herein, the windowed attention regions can extend at least in part beyond boundaries of at least one (e.g., each) patch of the plurality of patches. The one or more circuits can then be configured to provide updated image data according to the update, to generate the current image.

Real-time computer graphics are increasingly employing path tracing, ray tracing, full ray tracing, etc., techniques for simulating the propagation of light from light sources to a viewport (e.g., a virtual camera position). This can allow for the generation of more life-like images and/or more intuitive scene development for game studios and the like. However, because simulation of individual light paths is computationally very demanding and can involve setting a budget to trace for example just a single lighting sample per pixel to avoid errors and/or latencies when generating these life-like images. These budgets can result in extremely noisy images, and in order to obtain a good image many hundreds or thousands of such noisy samples per pixel must be simulated and averaged over. In some examples, to address this technical difficulty, real-time denoisers re-use information from multiple samples both spatially and temporally. To further accelerate the rendering process, the rasterization and/or path tracing stages can operate at a lower resolution than the final target resolution. In this case, it is beneficial to implement techniques to both denoise and upscale the computer-generated images. This process can be referred to as image reconstruction whereby high resolution images are generated from noisy low resolution samples.

In comparison to systems that involve convolution operations (e.g., image processing backbones that implement convolutional neural networks (CNNs)), the present disclosure implements attention operations in accordance with a transformer backbone to reduce noise when upscaling an image, allowing for generation of higher-quality images that are based at least on attention operations rather than convolution operations. This can address certain issues involved in using CNNs to reconstruct images such as increases in blurred out detail that occur as a result of lighting effects (e.g., processing of images having shadows and/or reflections), temporal instability, smudgy final results, and ghosting. And by virtue of the implementation of fully-fused kernels for evaluating each encoder and decoder stage of a neural network that implements a transformer-based backbone, individual layers and operations implemented by the transformer-based backbone can be carefully optimized to both improve image quality (and reduce noise, blurred out detail, temporal instability, smudging, and/or ghosting, in comparison to CNN-based backbones) while operating within a specific computing resource budget.

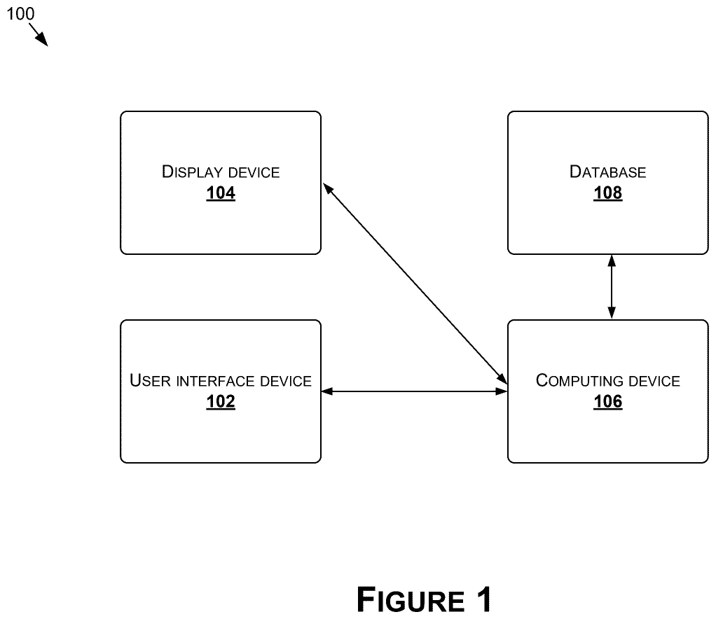

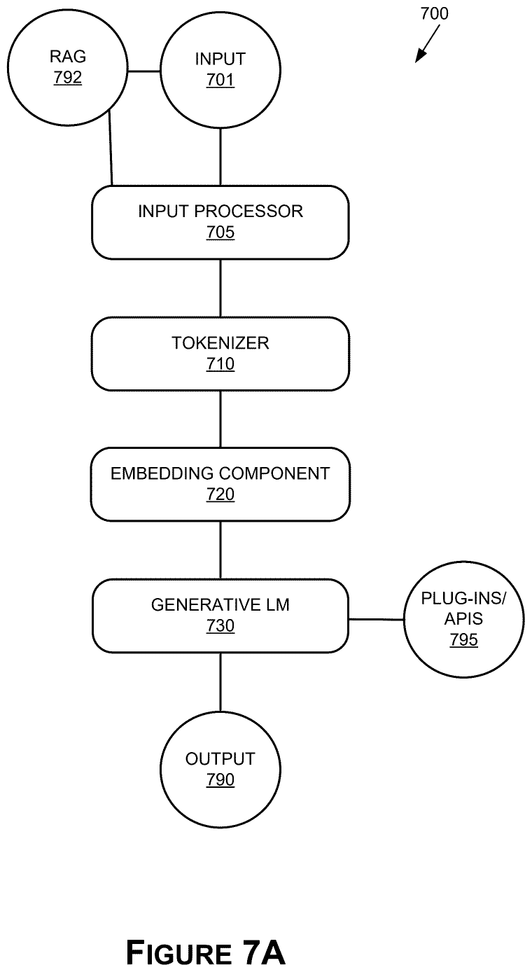

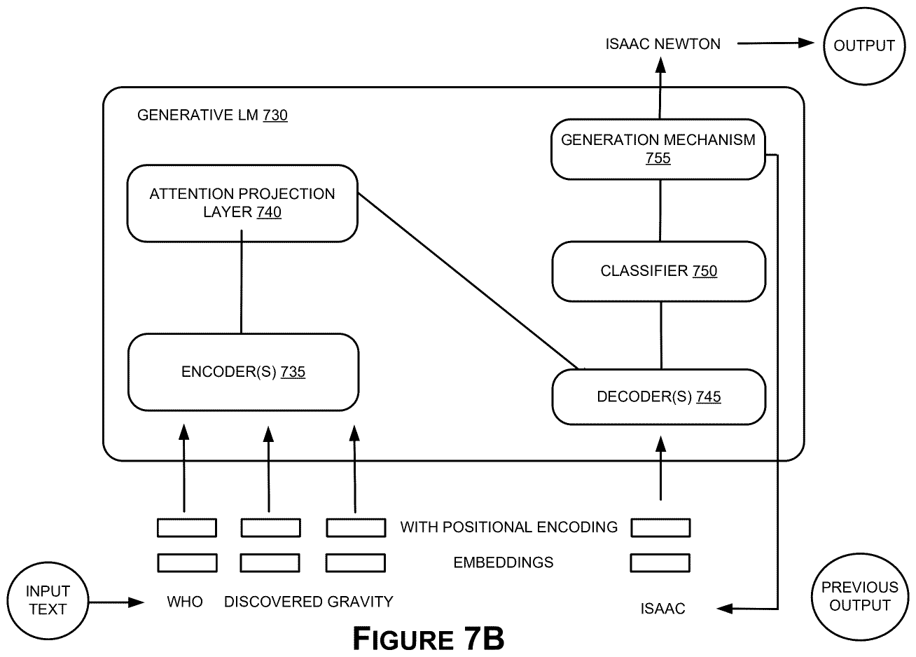

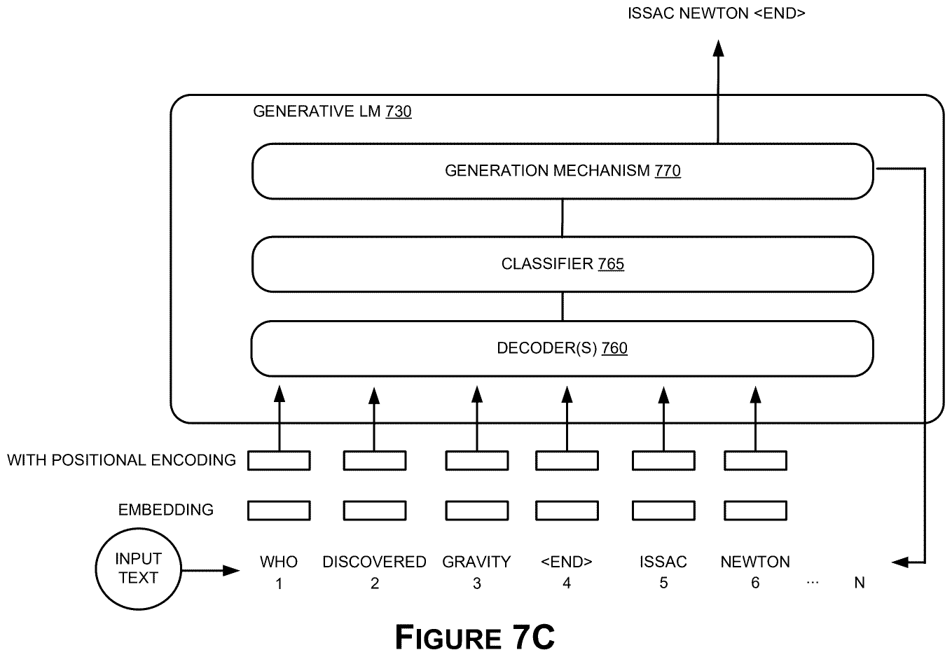

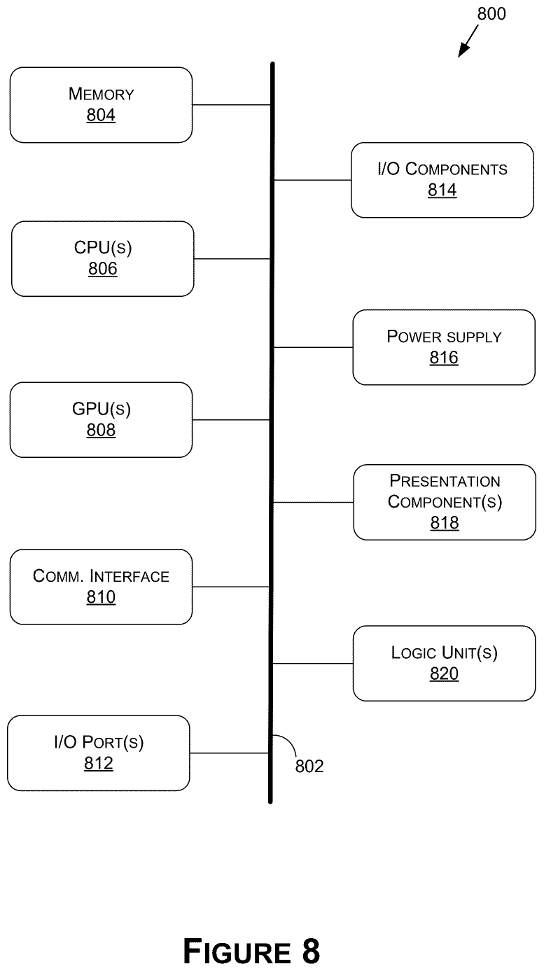

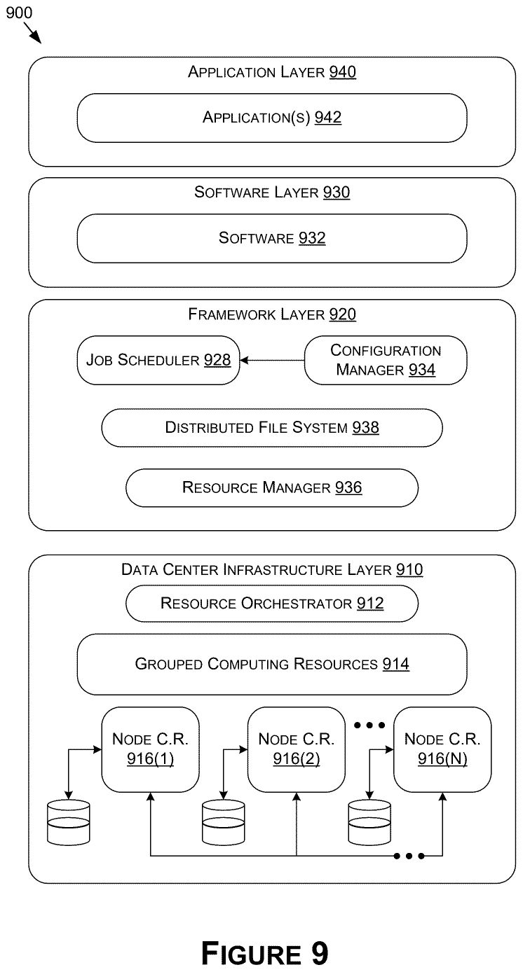

With reference to FIG. 1, FIG. 1 is an example an example environment 100 in which one or more devices operate to reduce noise when generating computer generated images, in accordance with some embodiments of the present disclosure. It should be understood that this and other arrangements described herein are set forth only as examples. Other arrangements and elements (e.g., machines, interfaces, functions, orders, groupings of functions, etc.) can be used in addition to or instead of those shown, and some elements can be omitted altogether. Further, many of the elements described herein are functional entities that can be implemented as discrete or distributed components or in conjunction with other components, and in any suitable combination and location. Various functions described herein as being performed by entities can be carried out by hardware, firmware, and/or software. For instance, various functions can be carried out by a processor executing instructions stored in memory. For example, in some embodiments, the system and methods described herein can be implemented using one or more generative language models (e.g., as described in FIGS. 7A-7C), one or more computing devices (e.g., as described in FIG. 8), and/or one or more data centers (e.g., as described in FIG. 9).

The environment 100 includes a user interface device 102, a display device 104, a computing device 106, and a database 108. In some embodiments, the user interface device 102, the display device 104, the computing device 106, and/or the database 108 can include one or more components that are the same as, or similar to, one or more components of the computing device as described in FIG. 8. In some embodiments, one or more of the devices of FIG. 1 can interconnect via one or more wired and/or wireless connections, such interconnections corresponding to one or more networks as described herein.

In some embodiments, the user interface device 102 can include one or more devices configured to be in communication with the computing device 106. For example, the user interface device 102 can include one or more devices configured to be in wired and/or wireless communication with the computing device 106, thereby establishing wired and/or wireless communication connections with the computing device 106. In some embodiments, the user interface device 102 can include a device that is configured to be manipulated by an individual and generate signals representing such manipulation by the individual. The user interface device 102 can then transmit the signals to the computing device 106 via the one or more wired and/or wireless communication connections. In some embodiments, the user interface device can include one or more of: a keyboard, a mouse, a joystick, and/or the like.

In some embodiments, the display device 104 can include one or more devices configured to be in communication with the computing device 106. For example, the display device 104 can include one or more devices configured to be in wired and/or wireless communication with the computing device 106, thereby establishing wired and/or wireless communication connections with the computing device 106. In some embodiments, the display device 104 can include a device that is configured to output one or more images generated by the computing device 106. For example, the display device 104 can include a device such as a computer monitor, a touchscreen, a mobile device display (e.g., a smartphone display), and/or the like.

In some embodiments, the computing device 106 can include one or more devices configured to be in communication with the user interface device 102, the display device 104, and/or the database 108. For example, the computing device 106 can include one or more devices configured to be in wired and/or wireless communication with the user interface device 102, the display device 104, and/or the database 108, thereby establishing wired and/or wireless communication connections with the computing device 106. In some embodiments, the computing device 106 can include a device that is configured to generate data associated with one or more images, the data associated with the one or more images configured to cause the display device 104 to display the one or more images. For example, the computing device 106 can include a device such as a mobile device (e.g., smartphone), a laptop, a desktop, a server, and/or the like.

In some embodiments, the database 108 can include one or more devices configured to be in communication with the computing device 106. For example, the database 108 can include one or more devices configured to be in wired and/or wireless communication with the computing device 106, thereby establishing wired and/or wireless communication connections with the computing device 106. In some embodiments, the database 108 can include a device that is configured to store data described herein such as, for example, data associated with a scene, data associated with one or more images, and/or the like. For example, the database 108 can include a device such as a memory as described herein.

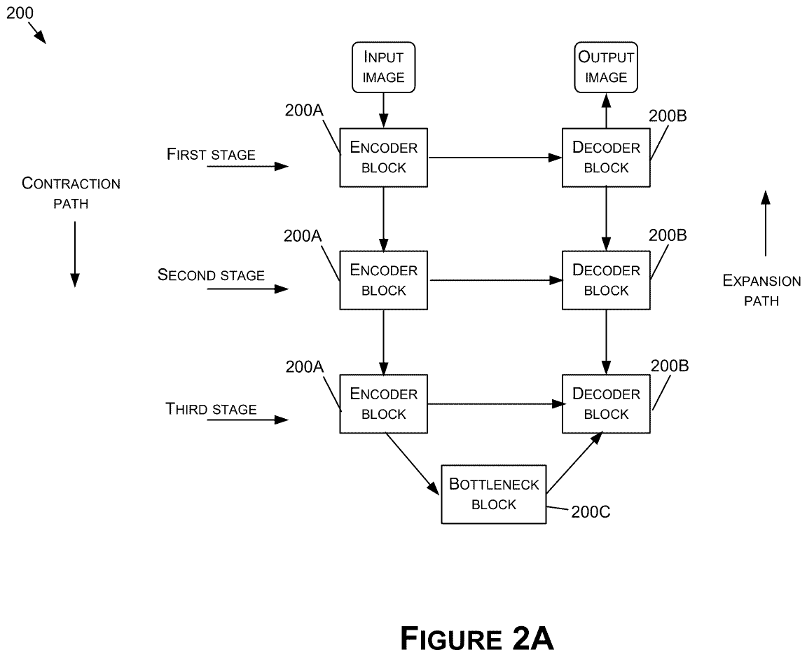

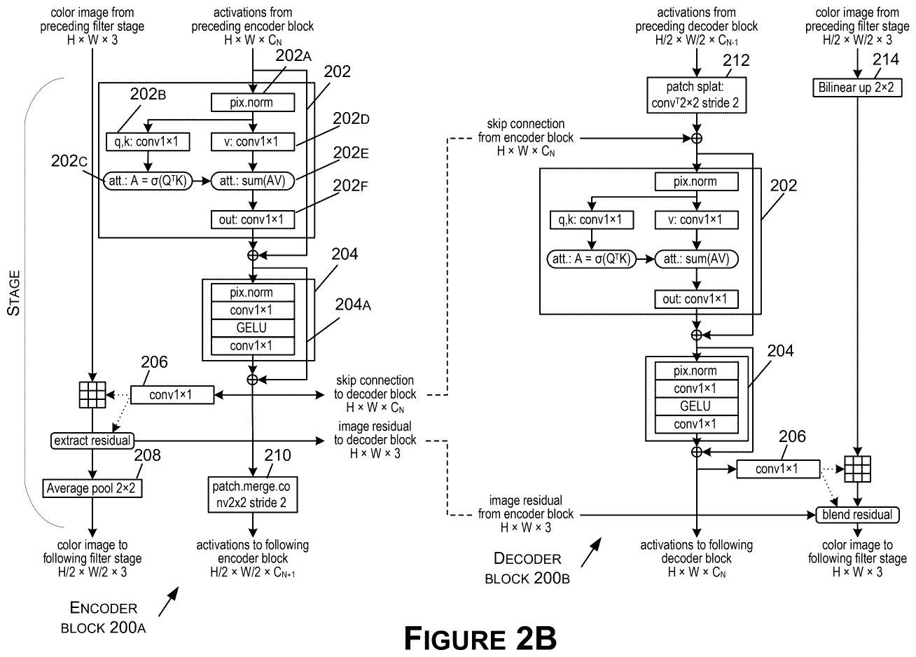

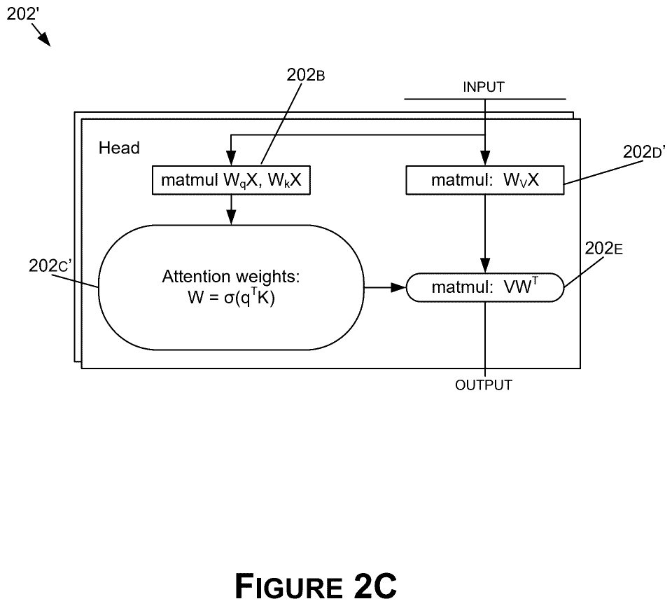

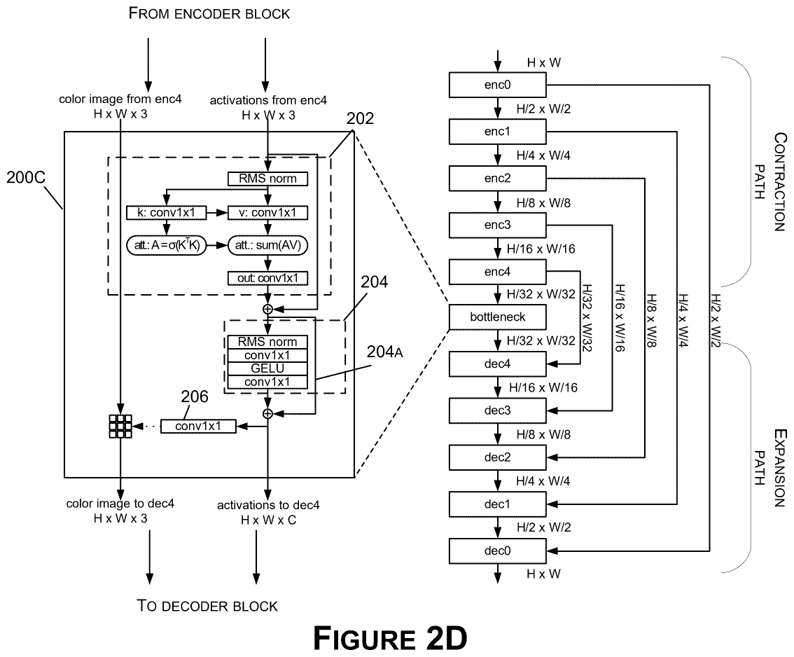

With continued reference to FIG. 1, in some embodiments, the computing device 106 can implement one or more model architectures (e.g., that are the same as, or similar to, the model architecture 200 of FIGS. 2A and 2B) during image reconstruction as described herein. For example, to reconstruct images generated as a result of one or more operations involved in ray tracing, etc., the computing device 106 can implement a multi-stage approach that involves a pre-pass stage, a filter stage (implementing one or more neural networks including attention-based neural networks as described herein), and/or a post-pass stage. In the pre-pass stage, input buffers including pixel values representing an image generated for a current frame (e.g., as a part of one or more successive frames) can be pre-processed to address noisy color and surface properties that result from a primary hit from a (virtual) camera position to primitives in a scene when first tracing a ray from a camera through a virtual environment. In this pre-pass stage, buffers from previous frames can also be warped to align with the geometry of a current frame (e.g., the updated position of objects as they move relative to the environment from frame to frame), associating a final reconstructed output color from a previous frame and/or a hidden or internal memory buffer. The surface properties can then be de-modulated to form the output color for each pixel of the image generated for a given frame.

In the filter stage, the computing device 106 can implement one or more spatial filters that are applied to noisy input colors in an image generated during the ray tracing process after the image is demodulated. For example, the computing device 106 can implement the spatial filter(s) using attention-based neural networks (also referred to as attention-based models) that are based at least on transformer architectures as described herein. In this example, the neural network(s) involved can generate outputs associated with predictions of temporal filtering coefficients (per pixel). These outputs can also be associated with upsampling kernels and/or hidden history channel(s) per pixel that can be used in subsequently-generated frames.

In the post-pass stage, the computing device 106 can implement one or more re-modulation techniques based at least on the surface properties of the primitives involved. The computing device 106 can then upsample the image being generated to increase the resolution of the image to a target resolution. Finally, the computing device 106 can determine colors for each pixel of the current image based at least on the upsampled image and/or the warped previous frame to finalize the image for the current frame.

Referring now to FIGS. 2A and 2B, illustrated is a diagram of an example model architecture 200, in accordance with some embodiments of the present disclosure. The model architecture 200 can be implemented at one or more stages in accordance with execution of a hierarchical vision transformer. At least one (e.g., each) stage can be associated with a given resolution, where successive stages (e.g., extending along a contracting path) are associated with successively-reduced resolutions. For example, the model architecture 200 can include a plurality of encoder blocks 200a that form a contracting path and a plurality of decoder blocks 200b forming an expanding path. In this example, each encoding block 200a can correspond to a specific decoder block 200b, with both further corresponding to a given stage. The encoder blocks 200a can each include a transformer module 202, a normalization-activation-convolution block (or “normalization layer”) 204, a convolution layer 206, a pooling layer 208, and/or a patch merge layer 210. The decoder blocks 200b can include a patch splat block 212, a bilinear block 214, a transformer module 202, a normalization layer 204, and/or a convolution layer 206. As described herein, the encoder blocks 200a and the decoder blocks 200b can communicate with one another via one or more skip connections at each stage, allowing for communication of information therebetween at various stages. Additionally, or alternatively, the third stage encoder block may communicate with the third stage decoder block through a bottleneck block 200c.

In some embodiments, the hierarchical vision transformer implemented by the model architecture 200 can include an attention-based neural network that is designed to efficiently process images by incorporating a window-based self-attention mechanism when performing operations to implement various computer vision tasks. For example, the hierarchical vision transformer can establish a hierarchical structure which allows the hierarchical vision transformer to execute operations at multiple scales (e.g., corresponding to a first stage, a second stage, etc. as shown in FIG. 2A). This can allow for the capture of both fine-grained local features (at stages associated with higher resolutions) and coarse global features at stages associated with lower resolutions). The stages (or levels) can include several layers of shifted window attention regions (also referred to as window attention blocks) that are used by respective transformer modules to execute one or more attention operations as described herein. This hierarchical approach can facilitate the extraction of rich feature representations across different levels of abstraction and/or different resolutions.

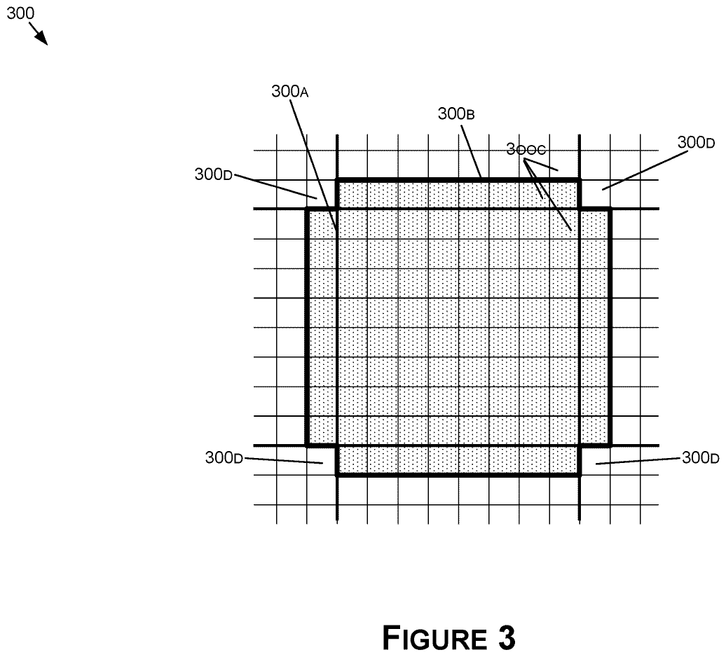

In some embodiments, the hierarchical vision transformer can implement a shifted window attention mechanism. For example, the hierarchical vision transformer can divide an input (e.g., an image at a first resolution) into window attention regions as described herein (see FIGS. 3-5), and execute self-attention operations for each window attention region. This can significantly reduce computational complexity when performing these self-attention operations while maintaining efficiency. The “shifted” aspect can refer to the overlapping windows in successive layers and/or offsets of the window attention regions at each stage, which enables cross-window connections and enhances feature representation.

Initially, at a first stage, an image can be obtained by a computing device (e.g., that is the same as, or similar to, the computing device 106 of FIG. 1). For example, when generating an image as part of a ray tracing process, the computing device can obtain (e.g., receive and/or execute one or more operations to generate) an image to be reconstructed. The image can be an image generated as a result of execution of one or more operations when performing ray tracing, etc., to visually represent a virtual environment from the point of view of a camera within that virtual environment. In some embodiments, the image can be provided to a first encoder block 200a along a contracting path of the model architecture 200. For example, the image can be provided to a first encoder block 200a that transforms the image (e.g., the values associated with each pixel) using a 2-layer Multi-Layer Perceptron (MLP) consisting of two 1×1 convolutional layers separated by a nonlinear activation function. Each input pixel can be associated with values that are associated with features to be updated including noisy colors, albedo (e.g., the fraction of incident light or radiation that is reflected by a surface or body represented by a given pixel or set of pixels), a surface normal for each pixel of the input image, and a previous output color associated with corresponding pixels within the image. The first 1×1 convolution layer can processes these features, combining them while maintaining spatial dimensions. The subsequent nonlinearity can introduce complexity to allowing downstream portions of the model architecture 200 to learn intricate relationships among the features. Finally, the second 1×1 convolution layer can transform the output into a 32-channel embedded representation (referred to as a feature map that can be provided to a subsequent encoder block 200a).

In another example, the image can be provided to a patch partition module (not explicitly illustrated). The patch partition module can be configured to divide the image into smaller patches (e.g., of a size of 4×4, 8×8 pixels, etc.). For example, in the context of an input image with a resolution of 224×224 that is divided into 4×4 patches, the input image can be provided to the patch partition module to be segmented into (224/4)×(224/4)=56×56=3136 patches. Similarly, in the context of an input image with a similar resolution that is divided into 8×8 patches, pixels can be provided to the patch partition module to be segmented into (224/8)×(224/8)=784 patches. Each patch can then be flattened and passed through a linear embedding layer, transforming each patch into a fixed-dimensional vector (token) that represents the patch in a specified embedding dimension. The output of the patch partition module can include a tensor of shape (B, N, C), where B is the batch size, N is the number of patches, and C is the embedding dimension. This transformation can allow efficient processing at subsequent stages by allowing the application of window-based self-attention mechanisms to windowed attention regions, which focus on local features within each patch and one or more adjacent patches while maintaining computational efficiency.

The tokens of at least one (e.g., each) patch (referred to for simplicity as patches) can be provided to an encoder block 200a that forms part of a contracting path of a hierarchical vision transformer implemented by the model architecture 200. The encoder block 200a can receive the patches and provide the patches to a transformer module 202. For example, the patches can be provided to the transformer module 202 that is configured to obtain the patches for a given image and normalize pixel values for each of the at least one patch across multiple channels (referred to as a root mean square (RMS) normalization layer (or RMS norm layer 202a)). In some examples, the RMS norm layer 202a can execute operations to normalize the pixel values across different channels (e.g., RGB) of an image to scale inputs based at least on a root mean square value derived from pixel values associated with each pixel. This can include adjusting normalization parameters dynamically based at least on the patches for a given image and/or set of images forming a feature map. The feature map can represent both the pixel values for portions of a given patch and/or image, as well as indications (e.g., labels) associated with each pixel of the image. While the present disclosure focuses on RGB images, it will be understood that any number of channels used to represent a two-dimensional image can be used.

For each of the at least one patch, the transformer module 202 can then provide a portion of the feature map corresponding to the patch to a first convolution layer 202b to apply separate 1×1 convolutional layers to the portion of the feature map (the output of the RMS norm layer 202a) and produce Query (Q) and Key (K) vectors. The output of the first convolution layer 202b can then be provided to a first attention layer 202c to be processed as described herein. Similarly, the transformer module 202 can provide the portion of the feature map corresponding to the patch to a second convolution layer 202d to apply separate 1×1 convolutional layers to the portion of the feature map corresponding to the patch to produce the Value (V) vectors. The output of the second convolution layer 202d can then be provided to the second attention layer 202e to be processed as described herein.

In some embodiments, the transformer module 202 can implement a first attention layer 202c that receives the Query (Q) and Key (K) vectors from the first convolution layer 202b. For example, the transformer module 202 can receive symmetric Query and Key vectors that are derived from the input image (e.g. and are identical) and provide the symmetric Query and Key vectors as an input to the transformer module. In this example, the input can be represented as a patch embedding. The first attention layer 202c can then perform one or more attention operations to calculate attention scores across a windowed attention region for each pixel of each of the at least one patch (represented by corresponding patch embeddings) by determining a dot product through of the Q and K vectors of the pixels corresponding to each patch. This can be followed by a softmax operation to normalize the scores. As described herein, normalizing the scores can include determining at least one threshold (e.g., a first threshold, a second threshold, etc.) that is used to update (e.g., bound) the scores represented by the determination of the dot product. These scores can represent the importance of each Value vector in relation to the Query (here, the pixels of given patches of the input image). In some embodiments, the scores output by the first attention layer 202c can be provided to a second attention layer 202e that sums the weighted Value vectors and multiples each Value vector by a corresponding attention score. This output can represent relevant information from the input features (e.g., represented by the pixels input to the transformer module 202), allowing the transformer module 202 to focus on portions of the image (e.g., sets of pixels within the image) while discarding less relevant information (other pixels within the image). The output of the second attention layer 202e (e.g., the weighted sum of values) can then be provided to a convolutional layer 202f that performs one or more convolution functions based at least on the feature map output by the second attention layer 202e and generates an output set of pixel values for the image at a given stage.

As described herein, the first attention layer 202c and/or the second attention layer 202e can be configured to perform one or more attention operations in accordance with a windowed attention region (e.g., that is the same as, or similar to, the windowed attention region 300 of FIG. 3) when processing each patch as described herein. For example, the first attention layer 202c and/or the second attention layer 202e can be configured to determine an offset for a windowed attention region overlaid onto each patch when analyzing each patch. The offset can include an offset to the windowed attention regions for each patch associated with a given portion of a feature map as described herein. As described herein, the first attention layer 202c and/or the second attention layer 202e can be configured to determine the offset, where the offset includes a set of shifts. The first attention layer 202c and/or the second attention layer 202e can then perform the one or more attention operations as described herein for a given patch in accordance with the offset to the windowed attention region to update the feature map being analyzed by the first attention layer 202c and/or the second attention layer 202e.

The second convolution layer 202d can be configured to reduce the dimensionality of the input image as represented by the feature map and feature transformation. For example, the second convolution layer 202d can be configured to reduce the dimensionality of the input image that is associated with a following stage, allowing for efficient computation while preserving spatial dimensions. The output of the second convolution layer 202d can then be provided as input to the second attention layer 202e.

In some embodiments, the second attention layer 202e can be configured to aggregate information from the Value (V) vectors based at least on computed attention scores. For example, the input to the second attention layer 202e can include the Query (Q) and Key (K) vectors output by the first convolution layer 202b, as well as the Value vectors output by the second convolution layer 202d, which are used to calculate attention scores through a dot product followed by a softmax operation. These attention scores determine the importance of each Value vector in relation to the Query (e.g., the image being processed at a given stage). The output of the second attention layer 202e can be obtained by summing the weighted Value vectors, where each Value vector is multiplied by its corresponding attention score represented by the output of the first attention layer 202c. This results in an output image that encapsulates relevant information from the input features, effectively allowing the model architecture 200 to process images and focus on important parts of the input image at each stage while discarding less relevant information.

In some embodiments, the model architecture 200 can implement a normalization layer 204. For example, the model architecture 200 can implement the normalization layer 204, which can be configured to receive the feature map output by the transformer module 202 and execute another RMS norm layer (e.g., that is the same as, or similar to, the RMS norm layer 202a), a convolution layer (e.g., that is the same as, or similar to, the first convolution layer 202b or the second convolution layer 202d), a Gaussian error linear unit (GELU), and another convolutional layer. For example, the normalization layer 204 can include a multilayer perceptron forming the RMS norm layer, the convolution layer, the GELU layer, and another convolution layer. For example, to allow for downsampling and/or increase abstraction levels, the feature map output by the transformer module 202 can be provided to another RMS norm layer to normalize the feature map. The output of the RMS norm layer can then be provided to the convolution layer to execute one or more convolution operations. The output of the convolution layer can be provided to the GELU to be used to execute activation function to determine a Gaussian distribution, allowing for a smoother transition compared to other activation functions. The output of the GELU can then be provided to another convolution layer to execute one or more convolution operations. When generated, the output of the normalization layer 204 can then be provided to the transformer module 202 of the decoder block 200b using a skip connection and to a convolution layer 206. The output of the normalization layer 204 can also be provided to a patch merge layer 210 that is configured to merge sets of patches that are based at least on the input image initially provided to the transformer module 202 to be provided to a subsequent encoder block along a contraction path of the hierarchical vision transformer. Additionally, the normalization layer 204 can also be associated with a residual connection 204a. For example, the normalization layer 204 can be associated with a residual connection 204a that allows portions of the feature map output by the transformer module 202 to be added to the output of the normalization layer 204.

In some embodiments, the output of the normalization layer 204 can be provided to the convolution layer 206. For example, the output of the normalization layer 204 can be provided to the convolution layer 206 that is the same as, or similar to, the first convolution layer 202b. The convolution layer 206 can execute one or more convolution operations and generate an output. The output of the convolution layer 206 can then be provided to an average pool layer 208.

In some embodiments, the average pool layer 208 can be configured to implement a 2×2 pooling window to reduce the spatial dimensions of the image provided as input to the encoder block 200a, both decreasing the computational resources used to process the feature map at subsequent layers as well as allowing the hierarchical vision transformer to capture essential features while ignoring minor variations and/or noise. In some embodiments, the average pool layer 208 can determine the average value of each 2×2 block of pixels, effectively extracting salient features from larger areas of the input and promoting translation invariance, making the hierarchical vision transformer less sensitive to the exact positioning of features. Additionally, this downsampling process can reduce the chances for overfitting by simplifying the representation and minimizing the number of parameters, ultimately improving both training efficiency and inference speed while maintaining the integrity of critical information.

In some embodiments, a patch merge layer 210 can be configured to merge sets of patches (associated with feature maps output by the normalization layer 204) from the input image processed by the transformer module 202 and the normalization layer 204 to be provided to a subsequent encoder block 200a along a contraction path formed by the model architecture 200 implementing the hierarchical vision transformer. For example, the patch merge layer 210 can include one or more modules that facilitate the reduction of the spatial dimensions of feature maps while merging information across patches. In examples, the patch merge layer 210 can operate by taking a series of patches from the input and concatenating their features (as represented by the corresponding feature map), followed by a linear transformation that combines the features from adjacent patches. This process can reduce the size of the feature map while enhancing the hierarchical vision transformer's ability to capture contextual information by integrating features from multiple patches.

In some embodiments, one or more components of the decoder block 200b can be the same as, or similar to, those described in the encoder block 200a and can form a portion of an expansion path of the hierarchical vision transformer. For example, a decoder block 200b can be configured to receive an output generated by an encoder block 200a (e.g., a final encoder block) that is located at the end of a contraction path of the model architecture 200. This output can include a version of the initial input image at a reduced resolution that is associated with the last stage of the model architecture 200 as well as a feature map.

In some embodiments, in response to receiving the outputs of the encoder block 200a (e.g., at the end of a contraction path), a bottleneck block 200c (described herein), or from a decoder block 200b (e.g., at a lower stage within the model architecture 200), the decoder block 200b can provide the image (e.g., output by the average pool layer 208 of the corresponding encoder block 200a, by the bottleneck block 200c, or by the earlier decoder block 200b) to a bilinear block 214 to generate a version of the image with an increase the resolution. For example, the bilinear block 214 can increase (e.g., expand) the resolution of the image output by the corresponding encoder block 200a for a given stage across a defined area (e.g., from a first resolution to a second resolution), allowing for upsampling of the image and/or enhancing spatial resolution of the image. By merging information from multiple patches, the bilinear block 214 can allow for contextual integration, enabling the model architecture 200 to capture complex spatial relationships and/or patterns represented across the various representations of the input image.

The decoder block 200b can also provide the feature map output by the corresponding encoder block 200a to a patch splat block 212. The patch splat block 212 can be configured to increase the spatial resolution of feature maps by interpolating pixel values corresponding to activations in the feature maps. In some examples, the patch splat block 212 can expand portions of the feature map into a 2×2 block in the output, utilizing bilinear interpolation, which calculates new pixel values corresponding to the activations in the feature maps based at least on a weighted average of the four nearest neighboring pixels. This approach can result in smoother transitions between pixels, reducing artifacts and/or pixelation compared other techniques (e.g., nearest-neighbor methods).

In some embodiments, the output of the patch splat block 212 can be provided to a transformer module 202. For example, the output of the patch splat block 212 can include a feature map that is provided either by an encoder block (at the last stage of the model architecture 200) or from a preceding decoder block 200b of an expansion path. The decoder block 200b can perform one or more operations as described above and generate an output feature map. The output feature map can then be provided to a normalization layer 204 of the decoder block 200b. Similarly, the normalization layer 204 can generate an output (e.g., a normalized version of the feature map) and provide the output to a convolution layer 206. The feature map output by the convolution layer 206 can be combined with the image output by the bilinear block 214 to form an upsampled image that is then provided to the next decoder block 200b along the expansion path of the model architecture 200. Similarly, the feature map output by the normalization layer 204 of the decoder block 200b can be provided to the next decoder block 200b along the expansion path. Once the final decoder block (at the first stage of the model architecture 200), the image output by the decoder block 200b can be provided as the output image of the model architecture 200.

With continued reference to FIGS. 2A and 2B, to train the model architecture 200, the computing device can prepare a training dataset. For example, the computing device can obtain data (e.g., images within a particular domain or group of domains) and, in some cases, normalize the data. In examples where the data includes a labeled dataset relevant to a specific task (e.g., image classification, object detection, segmentation, etc.), the computing device can obtain the data and process the data to include additional labels on a per-pixel basis indicating one or more aspects of the image (e.g., that given pixels correspond to edges, segmented portions of the image, etc.).

The computing device can then train and/or update the model architecture 200 by providing each image to the model architecture during a forward pass and comparing the output of the model architecture 200 with an expected output. The computing device can then calculate a loss based at least on the difference between the output of the model architecture 200 and the expected output. The computing device can then perform a backward pass to calculate gradients of the loss concerning the parameters of the model architecture 200, followed by weight updates using the selected optimizer. With respect to the example of image reconstruction, the model architecture 200 can be configured to receive an image and generate an output image (e.g., reducing noise, etc.). The computing device can compare the output of the model architecture 200 to a high resolution image (and in some cases, can generate a training dataset by downsampling high resolution images) and calculate the loss as described above. This process can be iteratively repeated until the difference between the output of the model architecture 200 and the expected output satisfies (e.g., is less than or equal to) a predetermined amount.

Referring now to FIG. 2C, FIG. 2C is an example transformer module 202, in accordance with some embodiments of the present disclosure. The transformer module 202′ of FIG. 2C can be the same as, or similar to, the transformer module 202 of FIG. 2B. For example, the transformer module 202′ can be configured to receive an input (e.g., from an RMS norm layer 202a). The output of the RMS norm layer 202a can then be provided to a first convolution layer 202b and a second convolution layer 202d′. The output of the first convolution layer 202b can be provided to a first attention layer 202c′ to cause the first attention layer 202c′ to execute one or more operations as described herein. The output of the first attention layer 202c′ can then be provided to a second attention layer 202e. The output of the second attention layer 202e can include a feature map as described herein.

In some embodiments, the attention weights can be determined (e.g., computed) for all tokens within a windowed attention region for a given patch by the first attention layer 202c′ as follows, where D denotes a head depth (length of query, key, and/or value vectors), M the token vector length/channel count (input and/or output of the head), and N the attention region size. From the perspective of a single output token within an attention head, the corresponding input token x is projected to a query vector q: q=W_{q}x q: [D, 1] W_{q}: [D, M] x: [M, 1]. The input tokens in the attention region arranged in a matrix X are projected to key vector matrix K: K=WₖX K: [D, N] Wₖ: [D, M] X: [M, N]. Next, the dot product between the query vector and the key vectors is computed: a=q^{T}K a: [1, N] q^{T}: [1, D] K: [D, N]. In the case of softmax based attention, an attention weight vector w is formed as: w=softmax (a):=exp (a)/sum (exp (a)), w: [1, N], where exp( ) denotes element-wise exponentiation.

In order to compute the output token, the input tokens within the attention region are provided to the second attention layer 202e and projected to Value vectors V: V=WᵥX V: [D, N] Wᵥ: [D, M] X: [M, N]. The output token y can be determined based at least on execution of one or more matrix multiplication operations resulting in a dot product of the weight vector and value vectors it attends to: y=Vw^{T} y: [D, 1] V: [D, N] w^{T}: [N, 1].

In some embodiments, a soft clamping function is applied to the dot product before taking the approximate exponential. The clamping function can be used to determine one or more threshold values and can be computed as:

$${a}^{′} = min ( max ( a , - C ) , C )$$

$${a}^{″} = {a}^{′} ( 1 - {Da}^{′} 2 ) + E$$

$$w = approx\_exp ( {a}^{″} ) / sum ( approx\_exp ( {a}^{″} ) ) ,$$

where the scalar constants C, D, E are set such that the operands a″ of the approx_exp function are configured to lie in the valid input range [A, B], and the mapping from a to a″ is continuously differentiable.

By implementing the soft clamping function as described, the operands of the approximate exponential function can be configured to lie in the valid range. The computation can include saturation and a cubic polynomial, which are operations that are fast to compute on the GPU. Further, the derivative of the soft saturation function f(a) is continuous which can improve training convergence, allowing the network to converge faster to a state where the dot products are in a range that where the saturation function is roughly linear, such that the whole attention block behaves similarly to standard softmax attention. And because there are no learnable parameters in the scheme, there is no need to fine tune the attention block for fast inference. This can reduce the use of computational resources when configuring the model architecture 200 as described herein.

Referring now to FIG. 2D, is an example bottleneck block 200c that can be configured to obtain input from an encoder block (e.g., that is the same as, or similar to, the encoder blocks 200a of FIGS. 2A and 2B) and provide an output to a decoder block (e.g., that is the same as, or similar to, the decoder blocks 200b of FIGS. 2A and 2B), in accordance with some embodiments of the present disclosure. In some embodiments, the bottleneck block 200c can include a transformer module 202, normalization layer 204, and/or a convolution layer 206. The transformer module 202, normalization layer 204, and convolution layer 206 of FIG. 2D can be the same as, or similar to, the transformer module 202, normalization layer 204, and convolution layer 206 of FIG. 2B. In some examples, the bottleneck block 200c can be configured to receive an input including a first image and/or patches from an encoder block 200a (e.g., a final encoder block along a contraction path of the model architecture 200). For example, the bottleneck block 200c can be configured to receive an image and/or a feature map from an encoder block 200a that is located at the end of the contraction path of the model architecture 200. In some embodiments, the transformer module 202 of the bottleneck block 200c can be configured to receive a feature map generated by a patch merge layer 210 of the encoder block 200a that is located at the end of the contraction path of the model architecture 200. The normalization layer 204 can receive the feature map and generate a normalized version of the feature map based at least on the feature map. The normalization layer 204 can then output the normalized version of the feature map and provide the normalized version of the output feature map to the convolution layer 206. The convolution layer 206 can execute one or more convolution operations based at least on the normalized feature map and generate an output. For example, the convolution layer 206 can generate an upsampled feature map based at least on upsampling the normalized feature map. In some examples, the output of the convolution layer 206 can be combined with the first image to form a second image. In an example wherein the convolution layer 206 generates the upsampled feature map, the second image can be an upsampled version of the first image. The patches and/or second image can be provided to a decoder block (e.g., a decoder block 200b at a stage that corresponds to the encoder block 200a that is located at the end of the contraction path of the model architecture 200).

Referring now to FIG. 3, FIG. 3 is an example windowed attention region 300, in accordance with some embodiments of the present disclosure. The windowed attention region 300 can be associated with a patch and used to instruct one or more attention operation as described above. As shown, the windowed attention region 300 can include a main portion 300a and a halo portion 300b (also referred to as a sub-region). The main portion 300a is shaped as an 8×8 pixel square, formed by 64 pixels from the pixels 300c in the windowed attention region 300. The corner elements 300d can be excluded from the halo portion 300b and main portion 300a of the windowed attention region 300, allowing for each of the 64 tokens in the patch to perform attention operations in accordance with 96 different tokens (corresponding to different pixels of the windowed attention region 300, further allowing for a maximally efficient matrix multiplication even in 8-bit floating point precision on a graphics processing unit (GPU) as described herein, as the dimensions are multiples of 32. As a result, the computational overhead involved in performing attention operations based at least on the pixels 300c of the halo portion 300b is that each tile must compute the key and value vectors for 96 tokens, while only producing 64 output tokens (e.g., the key and value projections include a 1.5× overhead). This allows for a smaller relative amount of computing resource consumption to allow for each token to be “aware” of the neighboring patches when compared with other attention-based techniques that involve performing attention operations based at least on pixels across an entire image.

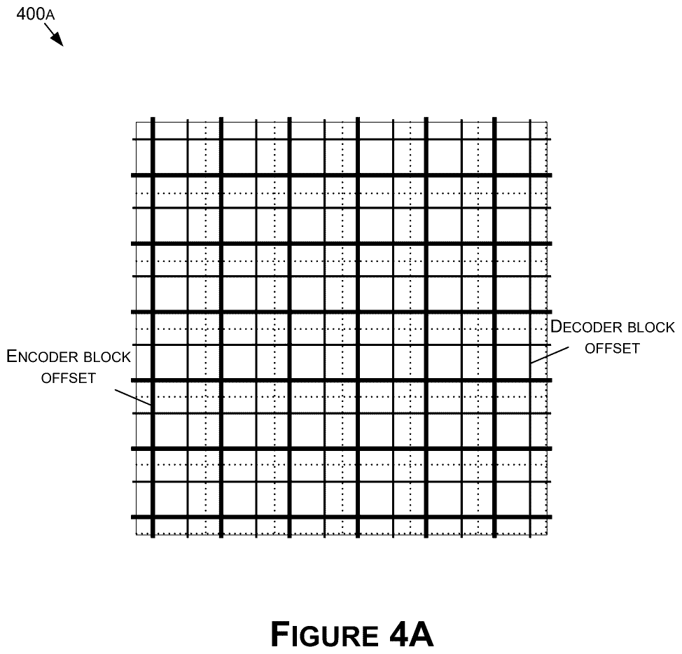

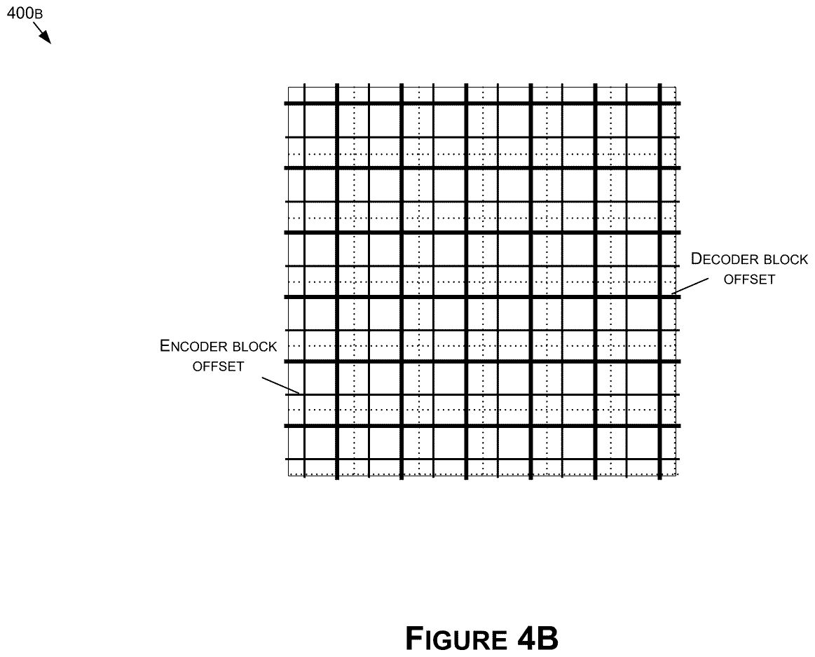

FIGS. 4A and 4B are examples of windowed attention region offsets for successive frames, in accordance with some embodiments of the present disclosure. To further improve artifact reduction (beyond the use of the windowed attention region 300 when processing each patch in accordance with the model architecture 200 of FIGS. 2A and 2B) different shifts/offsets to the patch grid in each block and also across multiple frames that correspond to images being reconstructed as described herein. These different shifts and/or offsets can be deterministic (e.g., can be updated in accordance with a predetermined set of shifts and/or offsets at each stage implemented by a model architecture (e.g., that is the same as, or similar to, the model architecture 200 of FIGS. 2A and 2B). Additionally, or alternatively, these different shifts and/or offsets can be dynamic and can be updated at each stage and at each transformer block at each stage such that the offsets are different across transformer blocks at different stages and/or across encoder blocks and decoder blocks at a given stage. In some embodiments, the shifts and/or offsets can also be updated dynamically for one or more transformer blocks based on time steps indexing a series of images received in sequence. For example, different shifts and/or offsets can be applied at the same transformer blocks and/or at the same stages when processing successive images in a time series of images. Having different shifts in different patches being processed relative to a given image for each stage can allow for spatial information to be propagated in each individual image (time step in a video stream). And temporally varying the shifts from frame to frame can allow any window boundary artifacts from one frame occur inside the tiles in the following frame.

As shown in FIGS. 4A and 4B, window shifts in an example embodiment of the invention. This illustration is highlighting the property of having different windows i) between encoder blocks (e.g., that are the same as, or similar to, the encoder blocks 200a of FIGS. 2A and 2B) and decoder blocks (e.g., that are the same as, or similar to, the decoder blocks 200b of FIGS. 2A and 2B) of the same resolution (e.g., at the same step) within a single image, and ii) across two consecutive frames for the corresponding encoder blocks and decoder blocks. As illustrated, the patch size is 8×8, and, when implemented, an encoder block can apply the encoder block offset (e.g., by shifting the windowed attention region for even frames 400a when processing a series of images using a model architecture 200) by 2 pixels horizontally and 6 pixels vertically, while the decoder block applies a shift of 6 pixels horizontally and 6 pixels vertically. In the odd frames 400b the shifting is switched, and the windowed attention region for even frames 400a are shifted by 2 pixels horizontally and 6 pixels vertically, and the decoder block applies a shift of 6 pixels horizontally and 6 pixels vertically. This way, the windowed attention region applied by the encoder block and the windowed attention region applied by the decoder block are as far apart as practicable when processing a given frame at a given stage. Similarly, for two consecutive frames the patches processed by the encoder windows can be as far apart as practicable from each other.

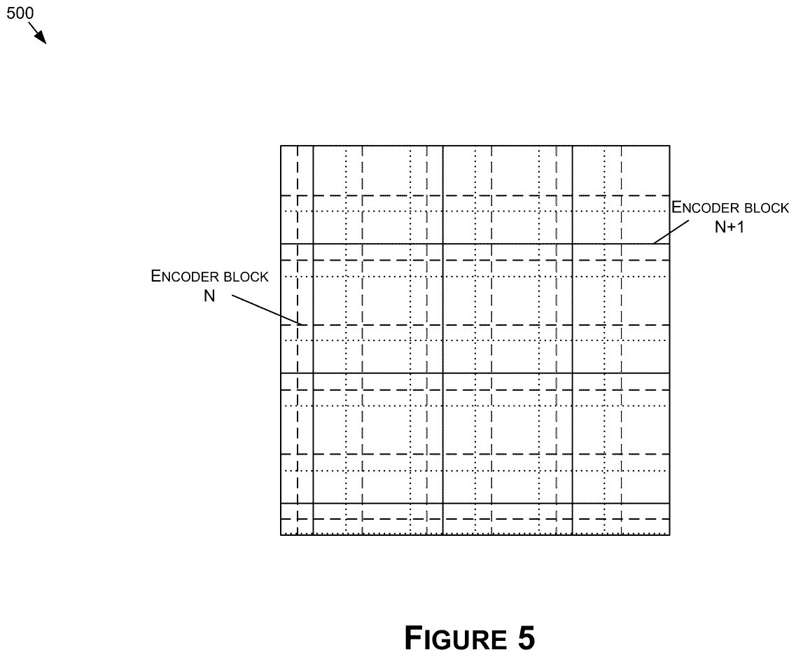

FIG. 5 is an example of windowed attention region offsets 500, in accordance with some embodiments of the present disclosure. As discussed, for consecutive encoder blocks and/or decoder blocks of a model architecture 200 (e.g., across successive stages implemented by the model architecture 200), the resolution of a given feature map can be halved when moving to the next encoder block and/or decoder block, and both patches can be 8×8 pixels in size. Both patches can apply the same shifts of 2 pixels horizontally and 6 pixels vertically. Applying the same shifts (as counted in number of pixels) in all encoder blocks of 2 (or 6), the consecutive blocks do not result in aligned windows.

The present disclosure describes specific shifts that can be applied to the attention windows applied when processing patches at varying stages during processing by a model architecture as described herein. It will be understood that the specific shifts illustrated herein are examples, and that other shifts and/or combinations of shifts can be applied. For example, the shifts between consecutive patches can be different, the period of temporal variation of the shifts can be greater than, or less than, every two stages, etc. In some embodiments, shifts can be pseudo-random, derived from a maximum discrepancy sequence, and/or derived from a Halton sequence. Another example sequence of shifts for each encoder block and/or decoder block of a model architecture 200 is included below.

| | Horizontal | Vertical | Horizontal | Vertical |
|---|---|---|---|---|
| | shift, even | shift, even | shift, odd | shift, odd |
| Block | frames | frames | frames | frames |
| Encoder 0 | 2 | 6 | 6 | 2 |
| Encoder 1 | 2 | 6 | 6 | 2 |
| Encoder 2 | 2 | 6 | 6 | 2 |
| Encoder 3 | 2 | 6 | 6 | 2 |
| Encoder 4 | 2 | 6 | 6 | 2 |
| Bottleneck | 0 | 0 | 0 | 0 |
| Decoder 4 | 6 | 2 | 2 | 6 |
| Decoder 3 | 6 | 2 | 2 | 6 |
| Decoder 2 | 6 | 2 | 2 | 6 |
| Decoder 1 | 6 | 2 | 2 | 6 |
| Decoder 0 | 6 | 2 | 2 | 6 |

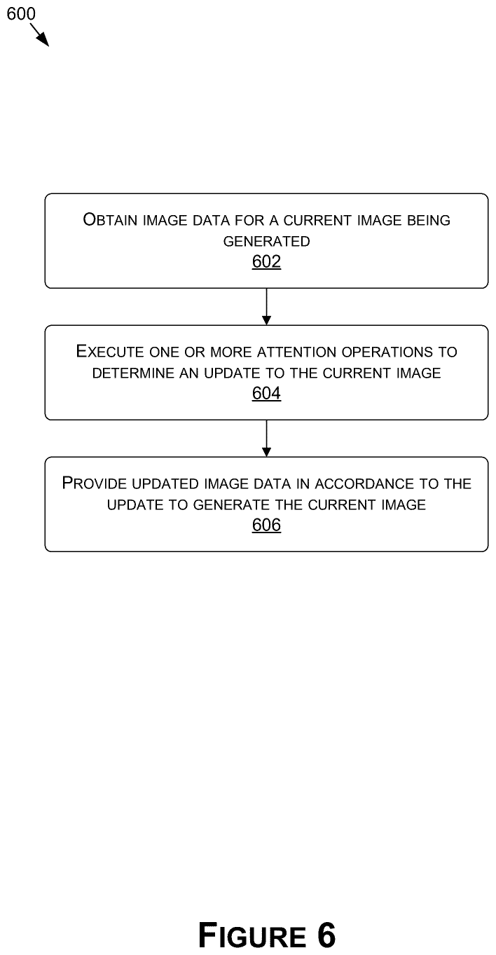

Now referring to FIG. 6, each block of method 600, described herein, comprises a computing process that can be performed using any combination of hardware, firmware, and/or software. For instance, various functions can be carried out by a processor executing instructions stored in memory. The method can also be embodied as computer-usable instructions stored on computer storage media. The method can be provided by a standalone application, a service or hosted service (standalone or in combination with another hosted service), as a microservice via an application programming interface (API) or a plug-in to another product, to name a few. In addition, method 600 is described, by way of example, with respect to the system of FIG. 1. However, this method can additionally or alternatively be executed by any one system, or any combination of systems, including, but not limited to, those described herein.

FIG. 6 is a flow diagram showing a method 600 for reducing noise when generating computer generated images, in accordance with some embodiments of the present disclosure. The method 600, at block 602, includes obtaining image data for a current image being generated. For example, a computing device (e.g., that is the same as, or similar to, the computing device 106 of FIG. 1 and/or the computing device 800 of FIG. 8) can be configured to execute one or more operations when performing ray tracing to generate an image or series of images. In this example, the computing device can be configured to implement a model architecture (e.g., that is the same as, or similar to, the model architecture 200 of FIGS. 2A and 2B). The computing device can then execute the model architecture to reconstruct images generate during the ray tracing process to improve the resolution of such images while removing defects such as noise, etc.

The method 600, at block 604, includes executing one or more attention operations to determine an update to the current image. For example, the computing device can be configured to execute the one or more attention operations to determine the update to the current image (e.g., generate a reconstructed image). In this example, the computing device can execute the one or more attention operations based at least on a plurality of patches. The plurality of patches can correspond to portions of the image being processed and/or can be sized based at least on the stage within the model architecture at which the model architecture is being processed.

In some embodiments, the computing device can be configured to execute the one or more attention operations based at least on a windowed attention region (e.g., that is the same as, or similar to, the windowed attention region 300 of FIG. 3 as described herein). For example, the computing device can execute the one or more attention operations (e.g., described with respect to the transformer module 202 of FIG. 2B). In examples, the windowed attention region of each patch can include a main portion and at least one sub-region that extends beyond the main portion.

In some embodiments, the computing device can determine a configuration for the windowed attention regions. For example, the computing device can determine the configuration for the windowed attention regions such that each pixel of the windowed attention regions identify tokens of the patch and one or more adjacent patches. In some examples, the computing device can also determine the configuration for the windowed attention regions by forgoing (e.g., not including) one or more pixels that are located diagonal relative to a main portion of the patch. In these examples, as shown in FIG. 3, the computing device can forgo including the diagonal pixels that would otherwise form a continuous halo portion around the patch. In some embodiments, when determining the configuration for the windowed attention regions, the computing device can determine one or more sub-regions that extend across patches that are adjacent to the patch being analyzed. For example, as shown in FIG. 3, the computing device can determine a sub-region that extends upward, to the right, downward, and to the left of the main portion 300a which defines the patch. While the windowed attention region is shown as having a main portion corresponding to an 8×8 set of pixels and a halo portion extending one pixel upward, downward, left, and/or right relative to the main portion of the patch, it will be understood that the main portion and the halo portion can form any desired shape and can extend along a greater number, or lesser number, of pixels in any direction relative to the main portion. Further, the windowed attention region can vary from stage to stage, and, in some instances, a different windowed attention region can be implemented by the encoder block and/or decoder block.

In some embodiments, the computing device can then determine an offset to the windowed attention region as described herein before executing one or more attention operations to update the values (e.g., colors, intensities, etc.) of each patch. For example, the computing device can first determine the pixels to include in the windowed attention region as described above. The computing device can then determine an offset (e.g., by shifting the windowed attention region up, down, left, right, and/or combinations thereof) that can cause the windowed attention region to move vertically and/or horizontally relative to the patch. In some examples, the offset can also cause the windowed attention region to only partially overlap the patch. The computing device can then apply the offset to the windowed attention region of each patch of the plurality of patches (e.g., for a given stage) and execute the one or more attention operations based at least on the application of the offset to the windowed attention regions.

In some embodiments, the computing device can then cause the one or more attention operations to be executed for each windowed attention region based at least on the pixels in the main portion and/or the halo portion as positioned relative to a given patch to update the patch. For example, the computing device can execute a first transformer module that is the same as, or similar to, the transformer module 202 of FIGS. 2A-2C along a contraction path of an attention-based model that is the same as, or similar to, the model architecture 200 of FIGS. 2A-2C based at least on first patch embeddings for the first plurality of patches to generate updated first patch embeddings. The computing device can then merge the updated first patch embeddings to form second patch embeddings e.g., that represent mergers between the patches of the image that represent the current image at a reduced resolution for a given stage. In some embodiments, the computing device can then execute a second transformer along the contraction path based at least on the second patch embeddings.

In some embodiments, the computing device can execute a transformer module at the end of the contraction path of an attention-based model as described above. The computing device can then merge the updated first patch embeddings to form second patch embeddings e.g., that represent mergers between the patches of the image that represent the current image at a reduced resolution for a given (e.g., final) stage of the attention-based model. In some embodiments, the computing device can then expand the second patch embeddings to form third patch embeddings; and execute a second transformer along the expansion path of the attention-based model based at least on the third patch embeddings. In this example, execution of the second transformer can include be configured to perform attention operations based at least on the expanded patch embeddings similar to as described above and provide the output to a subsequent transformer module along the expansion path. The attention-based model can then cause the subsequent transformer module to execute similar operations and provide outputs to subsequent transformer modules until completing the expansion path of the attention-based model, where the updated image data is output by the attention-based model.

The method 600, at block 606, includes providing updated image data in accordance to the update to generate the current image. For example, the computing device can provide the updated image data according to the update to generate the current image. The updated image data can include a filtered version of the image initially input into the model architecture. In some embodiments, the computing device can provide the updated image data to a display device (e.g., that is the same as, or similar to, the display device 104 of FIG. 1). For example, the computing device can provide the updated image data to a display device to cause the display device to generate the updated image.

The systems and methods described herein can be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets, cloud computing, generative AI, and/or any other suitable applications.

Disclosed embodiments can be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models-such as one or more large language models (LLMs) and/or one or more small language models (SLMs), one or more vision language models (VLMs), one or more multi-modal language models, etc., systems for performing light transport simulation, systems for performing collaborative content creation for 3D assets (e.g., using universal scene descriptor (USD) data, such as Open-USD, and/or other data types), systems implemented at least partially using cloud computing resources, and/or other types of systems.

### Example Language Models

In at least some embodiments, language models, such as large language models (LLMs) and/or other types of generative artificial intelligence (AI) and/or attention-based models can be implemented. For example, hierarchical vision transformer can be implemented in accordance with the principles described herein to reduce noise and/or other defects when reconstructing images generated based on ray tracing, etc., techniques. These models can be capable of understanding, summarizing, translating, and/or otherwise generating text (e.g., natural language text, code, etc.), images, video, computer aided design (CAD) assets, omniverse and/or metaverse file information (e.g., in USD format), and/or the like, based on the context provided in input prompts or queries. These language models can be considered “large,” in embodiments, based on the models being trained on massive datasets and having architectures with large number of learnable network parameters (weights and biases)—such as millions or billions of parameters. The LLMs/VLMs/etc. can be implemented for summarizing textual data, analyzing and extracting insights from data (e.g., textual, image, video, etc.), and generating new text/image/video/etc. in user-specified styles, tones, and/or formats. The LLMs of the present disclosure can be used exclusively for text processing, in embodiments, whereas in other embodiments, multimodal LLMs can be implemented to accept, understand, and/or generate text along with other types of content like images, audio, and/or video. For example, vision language models (VLMs), or more generally multimodal language models, can be implemented to accept image, video, audio, textual, 3D design (e.g., CAD), and/or other inputs data types and/or to generate or output image, video, audio, textual, 3D design, and/or other output data types.

Various types of LLM/VLM/etc. architectures can be implemented in various embodiments. For example, different architectures can be implemented that use different techniques for understanding and generating outputs-such as text, audio, video, image, etc. In some embodiments, LLM architectures such as recurrent neural networks (RNNs) or long short-term memory networks (LSTMs) can be used, while in other embodiments transformer architectures—such as those that rely on self-attention mechanisms—can be used to understand and recognize relationships between words or tokens. One or more generative processing pipelines that include LLMs can also include one or more diffusion block(s) (e.g., denoisers). The language models of the present disclosure can include encoder and/or decoder block(s). For example, discriminative or encoder-only LLMs like BERT (Bidirectional Encoder Representations from Transformers) can be implemented for tasks that involve language comprehension such as classification, sentiment analysis, question answering, and named entity recognition. As another example, generative or decoder-only LLMs like GPT (Generative Pretrained Transformer) can be implemented for tasks that involve language and content generation such as text completion, story generation, and dialogue generation. LLMs that include both encoder and decoder components like T5 (Text-to-Text Transformer) can be implemented to understand and generate content, such as for translation and summarization. These examples are not intended to be limiting, and any architecture type-including but not limited to those described herein—can be implemented depending on the particular embodiment and the task(s) being performed using the model(s).

In various embodiments, the LLMs/VLMs/etc. can be trained using unsupervised learning, in which an LLM learns patterns from large amounts of unlabeled text/audio/video/image/etc. data. Due to the extensive training, in embodiments, the models can not require task-specific or domain-specific training. LLMs that have undergone extensive pre-training on vast amounts of unlabeled text data can be referred to as foundation models and can be adept at a variety of tasks like question-answering, summarization, filling in missing information, and translation. Some LLMs can be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/etc. of the present disclosure can be implemented using various model alignment techniques. For example, in some embodiments, guardrails can be implemented to identify improper or undesired inputs (e.g., prompts) and/or outputs of the models. In some non-limiting embodiments, the guardrails implemented can be similar to those described in U.S. patent application Ser. No. 18/304,341, filed on Apr. 20, 2023, the contents of which are hereby incorporated by reference in their entirety. In some embodiments, one or more additional models- or layers thereof-can be implemented to identify issues with inputs and/or outputs of the models. For example, these “safeguard” models can be trained to identify inputs and/or outputs that are “safe” or otherwise okay or desired and/or that are “unsafe” or are otherwise undesired for the particular application/implementation. As a result, the LLMs/VLMs/etc. of the present disclosure can be less likely to output language/text/audio/etc. that can be offensive, vulgar, improper, unsafe, out of domain, and/or otherwise undesired for the particular application/implementation.

In some embodiments, the LLMs/VLMs/etc. can be configured to or capable of accessing or using one or more plug-ins, application programming interfaces (APIs), databases, data stores, repositories, etc. For example, for certain tasks or operations that the model is not ideally suited for, the model can have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model can access one or more restaurant or weather plug-ins (e.g., via one or more APIs) to retrieve the relevant information. As another example, where at least part of a response requires a mathematical computation, the model can access one or more math plug-ins or APIs for help in solving the problem(s) and can then use the response from the plug-in and/or API in the output from the model. This process can be repeated—e.g., recursively—for any number of iterations and using any number of plug-ins and/or APIs until a response to the input prompt can be generated that addresses each ask/question/request/process/operation/etc. As such, the model(s) can not only rely on its own knowledge from training on a large dataset(s), but also on the expertise or optimized nature of one or more external resources—such as APIs, plug-ins, and/or the like.

In some embodiments, multiple language models (e.g., LLMs/VLMs/etc., multiple instances of the same language model, and/or multiple prompts provided to the same language model or instance of the same language model can be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g., updated) corpuses of data can be provided with the same input query and prompt (e.g., set of constraints, conditioners, etc.). In one or more embodiments, the language models can be different versions of the same foundation model. In one or more embodiments, at least one language model can be instantiated as multiple agents—e.g., more than one prompt can be provided to constrain, direct, or otherwise influence a style, a content, or a character, etc., of the output provided. In one or more example, non-limiting embodiments, the same language model can be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model can be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model can be asked to generate or otherwise obtain an output with respect to an input source material, with the output being associated with the input source material. Such an association can include, for example, the generation of a caption or portion of text that is embedded (e.g., as metadata) with an input source text or image. In one or more embodiments, an output of a language model can be used to determine the validity of an input source material for further processing, or inclusion in a dataset. For example, a language model can be used to assess the presence (or absence) of a target word in a portion of text or an object in an image, with the text or image being annotated to note such presence (or lack thereof). Alternatively, the determination from the language model can be used to determine whether the source material should be included in a curated dataset, for example and without limitation.

Approaches in accordance with various embodiments can be used to generate one or more parameters for a content generation environment. In at least one embodiment, a trained machine learning (ML) and/or artificial intelligence (AI) system, such as a large language model (LLM) or a vision language model (VLM), may be used to generate parameters for the content generation environment, such as, but not limited to, camera settings, scene lighting, video parameters, and/or the like, used for displaying objects within a scene. The parameters may be based on an input provided by a user or a proxy for a user to a trained language model (e.g., LLM, VLM, etc.) that can then generate one or more settings in accordance with the input. Various embodiments may be used to generate settings in two-dimensional (2D) or three-dimensional (3D) settings. For embodiments that incorporate one or more language models—that is, one or more LLMs, one or more VLMs, or a combination of LLMs and VLMs, the language model(s) may receive an input (e.g., a prompt, a request, a query, etc.) that is parsed or otherwise formatted to generate a deterministic output. For example, the input provided to the language model may include a particular format for the output results, an example of desired output results, a particular list of parameters and their respective formatting, and the like. An input generator (e.g., a prompt generator), which may be driven or otherwise guided by one or more AI and/or ML systems, may be used to generate this input based on an initial input received from a user, a device, a proxy, and/or the like. A modified input generated by the input generator may then be provided to the language model, which will generate an output set of parameters. This output may be further evaluated with a reviewer, or other system, to ensure that the output is appropriate. Thereafter, a configuration file may be generated and/or the parameters may be directly provided to an environment to configure different components (e.g., camera settings, lighting, etc.) based on the parameters generated by the language model.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or at least one model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs-such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications-such as NVIDIA's TensorRT), and/or enterprise management data for telemetry (e.g., including identity, metrics, health checks, and/or monitoring).

The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

FIG. 7A is a block diagram of an example generative language model system 700 suitable for use in implementing at least some embodiments of the present disclosure. In the example illustrated in FIG. 7A, the generative language model system 700 includes a retrieval augmented generation (RAG) component 792, an input processor 705, a tokenizer 710, an embedding component 720, plug-ins/APIs 795, and a generative language model (LM) 730 (which can include an LLM, a VLM, a multi-modal LM, etc.).

At a high level, the input processor 705 can receive an input 701 comprising text and/or other types of input data (e.g., audio data, video data, image data, sensor data (e.g., LiDAR, RADAR, ultrasonic, etc.), 3D design data, CAD data, universal scene descriptor (USD) data, etc.), depending on the architecture of the generative LM 730. In some embodiments, the input 701 includes plain text in the form of one or more sentences, paragraphs, and/or documents. Additionally, or alternatively, the input 701 can include numerical sequences, precomputed embeddings (e.g., word or sentence embeddings), and/or structured data (e.g., in tabular formats, JSON, or XML). In some implementations in which the generative LM 730 is capable of processing multimodal inputs, the input 701 can combine text with image data, audio data, and/or other types of input data, such as but not limited to those described herein. Taking raw input text as an example, the input processor 705 can prepare raw input text in various ways. For example, the input processor 705 can perform various types of text filtering to remove noise (e.g., special characters, punctuation, HTML tags, stopwords) from relevant textual content. In an example involving stopwords (common words that tend to carry little semantic meaning), the input processor 705 can remove stopwords to reduce noise and focus the generative LM 730 on more meaningful content. The input processor 705 can apply text normalization, for example, by converting all characters to lowercase, removing accents, and/or or handling special cases like contractions or abbreviations to ensure consistency. These are just a few examples, and other types of input processing can be applied.

In some embodiments, a RAG component 792 can be used to retrieve additional information to be used as part of the input 701 or prompt. For example, in some embodiments, the input 701 can be generated using the query or input to the model (e.g., a question, a request, etc.) in addition to data retrieved using the RAG component 792. In some embodiments, the input processor 705 can analyze the input 701 and communicate with the RAG component 792 (or the RAG component 792 can be part of the input processor 705, in embodiments) in order to identify relevant text and/or other data to provide to the generative LM 730 as additional context or sources of information from which to identify the response, answer, or output 790, generally. For example, where the input indicates that the user is interested in a desired tire pressure for a particular make and model of vehicle, the RAG component 792 can retrieve—using a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 792 can retrieve a prior stored conversation history—or at least a summary thereof—and include the prior conversation history along with the current ask/request as part of the input 701 to the generative LM 730.

The tokenizer 710 can segment the (e.g., processed) text into smaller units (tokens) for subsequent analysis and processing. The tokens can represent individual words, subwords, characters, etc., depending on the implementation. Word-based tokenization divides the text into individual words, treating each word as a separate token. Subword tokenization breaks down words into smaller meaningful units (e.g., prefixes, suffixes, stems), enabling the generative LM 730 to understand morphological variations and handle out-of-vocabulary words more effectively. Character-based tokenization represents each character as a separate token, enabling the generative LM 730 to process text at a fine-grained level. The choice of tokenization strategy can depend on factors such as the language being processed, the task at hand, and/or characteristics of the training dataset. As such, the tokenizer 710 can convert the (e.g., processed) text into a structured format according to tokenization schema being implemented in the particular embodiment.

The embedding component 720 can use any known embedding technique to transform discrete tokens into (e.g., dense, continuous vector) representations of semantic meaning. For example, the embedding component 720 can use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 701 includes image data, the input processor 705 can resize the image data to a standard size compatible with format of a corresponding input channel and/or can normalize pixel values to a common range (e.g., 0 to 1) to ensure a consistent representation, and the embedding component 720 can encode the image data using any known technique (e.g., using one or more convolutional neural networks (CNNs) to extract visual features). In some implementations in which the input 701 includes audio data, the input processor 705 can resample an audio file to a consistent sampling rate for uniform processing, and the embedding component 720 can use any known technique to extract and encode audio features-such as in the form of a spectrogram (e.g., a mel-spectrogram). In some implementations in which the input 701 includes video data, the input processor 705 can extract frames or apply resizing to extracted frames, and the embedding component 720 can extract features such as optical flow embeddings or video embeddings and/or can encode temporal information or sequences of frames. In some implementations in which the input 701 includes multimodal data, the embedding component 720 can fuse representations of the different types of data (e.g., text, image, audio) using techniques like early fusion (concatenation), late fusion (sequential processing), attention-based fusion, etc.

The generative LM 730 and/or other components of the generative LLM system 700 can use different types of neural network architectures depending on the implementation. For example, transformer-based architectures such as those used in models like GPT can be implemented, and can include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multimodal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 720 can apply an encoded representation of the input 701 to the generative LM 730, and the generative LM 730 can process the encoded representation of the input 701 to generate an output 790, which can include responsive text and/or other types of data.

As described herein, in some embodiments, the generative LM 730 can be configured to access or use—or capable of accessing or using—plug-ins/APIs 795 (which can include one or more plug-ins, application programming interfaces (APIs), databases, data stores, repositories, etc.). For example, for certain tasks or operations that the generative LM 730 is not ideally suited for, the model can have instructions (e.g., as a result of training, and/or based on instructions in a given prompt, such as those retrieved using the RAG component 792) to access one or more plug-ins/APIs 795 (e.g., 3^{rd} party plugins) for help in processing the current input. In such an example, where at least part of a prompt is related to restaurants or weather, the model can access one or more restaurant or weather plug-ins (e.g., via one or more APIs), send at least a portion of the prompt related to the particular plug-in/API 795 to the plug-in/API 795, the plug-in/API 795 can process the information and return an answer to the generative LM 730, and the generative LM 730 can use the response to generate the output 790. This process can be repeated —e.g., recursively—for any number of iterations and using any number of plug-ins/APIs 795 until an output 790 that addresses each ask/question/request/process/operation/etc. from the input 701 can be generated. As such, the model(s) can not only rely on its own knowledge from training on a large dataset(s) and/or from data retrieved using the RAG component 792, but also on the expertise or optimized nature of one or more external resources-such as the plug-ins/APIs 795.

FIG. 7B is a block diagram of an example implementation in which the generative LM 730 includes a transformer encoder-decoder. For example, assume input text such as “Who discovered gravity” is tokenized (e.g., by the tokenizer 710 of FIG. 7A) into tokens such as words, and each token is encoded (e.g., by the embedding component 720 of FIG. 7A) into a corresponding embedding (e.g., of size 512). Since these token embeddings typically do not represent the position of the token in the input sequence, any known technique can be used to add a positional encoding to each token embedding to encode the sequential relationships and context of the tokens in the input sequence. As such, the (e.g., resulting) embeddings can be applied to one or more encoder(s) 735 of the generative LM 730.

In an example implementation, the encoder(s) 735 forms an encoder stack, where each encoder includes a self-attention layer and a feedforward network. In an example transformer architecture, each token (e.g., word) flows through a separate path. As such, each encoder can accept a sequence of vectors, passing each vector through the self-attention layer, then the feedforward network, and then upwards to the next encoder in the stack. Any known self-attention technique can be used. For example, to calculate a self-attention score for each token (word), a query vector, a key vector, and a value vector can be created for each token, a self-attention score can be calculated for pairs of tokens by taking the dot product of the query vector with the corresponding key vectors, normalizing the resulting scores, multiplying by corresponding value vectors, and summing weighted value vectors. The encoder can apply multi-headed attention in which the attention mechanism is applied multiple times in parallel with different learned weight matrices. Any number of encoders can be cascaded to generate a context vector encoding the input. An attention projection layer 740 can convert the context vector into attention vectors (keys and values) for the decoder(s) 745.

In an example implementation, the decoder(s) 745 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 735, in an example transformer architecture, each token (e.g., word) flows through a separate path in the decoder(s) 745. During a first pass, the decoder(s) 745, a classifier 750, and a generation mechanism 755 can generate a first token, and the generation mechanism 755 can apply the generated token as an input during a second pass. The process can repeat in a loop, successively generating and adding tokens (e.g., words) to the output from the preceding pass and applying the token embeddings of the composite sequence with positional encodings as an input to the decoder(s) 745 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 735, except that it creates its queries from the layer below it and takes the keys and values (e.g., matrix) from the output of the encoder(s) 735.

As such, the decoder(s) 745 can output some decoded (e.g., vector) representation of the input being applied during a particular pass. The classifier 750 can include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 755 can select or sample a word or token based on a corresponding predicted probability (e.g., select the word with the highest predicted probability) and append it to the output from a previous pass, generating each word or token sequentially. The generation mechanism 755 can repeat the process, triggering successive decoder inputs and corresponding predictions until selecting or sampling a symbol or token that represents the end of the response, at which point, the generation mechanism 755 can output the generated response.

FIG. 7C is a block diagram of an example implementation in which the generative LM 730 includes a decoder-only transformer architecture. For example, the decoder(s) 760 of FIG. 7C can operate similarly as the decoder(s) 745 of FIG. 7B except each of the decoder(s) 760 of FIG. 7C omits the encoder-decoder self-attention layer (since there is no encoder in this implementation). As such, the decoder(s) 760 can form a decoder stack, where each decoder includes a self-attention layer and a feedforward network. Furthermore, instead of encoding the input sequence, a symbol or token representing the end of the input sequence (or the beginning of the output sequence) can be appended to the input sequence, and the resulting sequence (e.g., corresponding embeddings with positional encodings) can be applied to the decoder(s) 760. As with the decoder(s) 745 of FIG. 7B, each token (e.g., word) can flow through a separate path in the decoder(s) 760, and the decoder(s) 760, a classifier 765, and a generation mechanism 770 can use auto-regression to sequentially generate one token at a time until predicting a symbol or token that represents the end of the response. The classifier 765 and the generation mechanism 770 can operate similarly as the classifier 750 and the generation mechanism 755 of FIG. 7B, with the generation mechanism 770 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures can be implemented within the scope of the present disclosure.

### Example Computing Device

FIG. 8 is a block diagram of an example computing device(s) 800 suitable for use in implementing some embodiments of the present disclosure (e.g., as the computing device 106 and/or the computing device described in accordance with the model architecture 200 of FIGS. 2A and 2B). Computing device 800 can include an interconnect system 802 that directly or indirectly couples the following devices: memory 804, one or more central processing units (CPUs) 806, one or more graphics processing units (GPUs) 808, a communication interface 810, input/output (I/O) ports 812, input/output components 814, a power supply 816, one or more presentation components 818 (e.g., display(s)), and one or more logic units 820. In at least one embodiment, the computing device(s) 800 can comprise one or more virtual machines (VMs), and/or any of the components thereof can comprise virtual components (e.g., virtual hardware components). For non-limiting examples, one or more of the GPUs 808 can comprise one or more vGPUs, one or more of the CPUs 806 can comprise one or more vCPUs, and/or one or more of the logic units 820 can comprise one or more virtual logic units. As such, a computing device(s) 800 can include discrete components (e.g., a full GPU dedicated to the computing device 800), virtual components (e.g., a portion of a GPU dedicated to the computing device 800), or a combination thereof.

Although the various blocks of FIG. 8 are shown as connected via the interconnect system 802 with lines, this is not intended to be limiting and is for clarity only. For example, in some embodiments, a presentation component 818, such as a display device, can be considered an I/O component 814 (e.g., if the display is a touch screen). As another example, the CPUs 806 and/or GPUs 808 can include memory (e.g., the memory 804 can be representative of a storage device in addition to the memory of the GPUs 808, the CPUs 806, and/or other components). As such, the computing device of FIG. 8 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 8.

The interconnect system 802 can represent one or more links or busses, such as an address bus, a data bus, a control bus, or a combination thereof. The interconnect system 802 can include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 806 can be directly connected to the memory 804. Further, the CPU 806 can be directly connected to the GPU 808. Where there is direct, or point-to-point connection between components, the interconnect system 802 can include a PCIe link to carry out the connection. In these examples, a PCI bus need not be included in the computing device 800.

The memory 804 can include any of a variety of computer-readable media. The computer-readable media can be any available media that can be accessed by the computing device 800. The computer-readable media can include both volatile and nonvolatile media, and removable and non-removable media. By way of example, and not limitation, the computer-readable media can comprise computer-storage media and communication media.

The computer-storage media can include both volatile and nonvolatile media and/or removable and non-removable media implemented in any method or technology for storage of information such as computer-readable instructions, data structures, program modules, and/or other data types. For example, the memory 804 can store computer-readable instructions (e.g., that represent a program(s) and/or a program element(s), such as an operating system. Computer-storage media can include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. As used herein, computer storage media does not comprise signals per se.

The computer storage media can embody computer-readable instructions, data structures, program modules, and/or other data types in a modulated data signal such as a carrier wave or other transport mechanism and includes any information delivery media. The term “modulated data signal” can refer to a signal that has one or more of its characteristics set or changed in such a manner as to encode information in the signal. By way of example, and not limitation, the computer storage media can include wired media such as a wired network or direct-wired connection, and wireless media such as acoustic, RF, infrared and other wireless media. Combinations of any of the above should also be included within the scope of computer-readable media.

The CPU(s) 806 can be configured to execute at least some of the computer-readable instructions to control one or more components of the computing device 800 to perform one or more of the methods and/or processes described herein. The CPU(s) 806 can each include one or more cores (e.g., one, two, four, eight, twenty-eight, seventy-two, etc.) that are capable of handling a multitude of software threads simultaneously. The CPU(s) 806 can include any type of processor and can include different types of processors depending on the type of computing device 800 implemented (e.g., processors with fewer cores for mobile devices and processors with more cores for servers). For example, depending on the type of computing device 800, the processor can be an Advanced RISC Machines (ARM) processor implemented using Reduced Instruction Set Computing (RISC) or an x86 processor implemented using Complex Instruction Set Computing (CISC). The computing device 800 can include one or more CPUs 806 in addition to one or more microprocessors or supplementary co-processors, such as math co-processors.

In addition to or alternatively from the CPU(s) 806, the GPU(s) 808 can be configured to execute at least some of the computer-readable instructions to control one or more components of the computing device 800 to perform one or more of the methods and/or processes described herein. One or more of the GPU(s) 808 can be an integrated GPU (e.g., with one or more of the CPU(s) 806 and/or one or more of the GPU(s) 808 can be a discrete GPU. In embodiments, one or more of the GPU(s) 808 can be a coprocessor of one or more of the CPU(s) 806. The GPU(s) 808 can be used by the computing device 800 to render graphics (e.g., 3D graphics) or perform general purpose computations. For example, the GPU(s) 808 can be used for General-Purpose computing on GPUs (GPGPU). The GPU(s) 808 can include hundreds or thousands of cores that are capable of handling hundreds or thousands of software threads simultaneously. The GPU(s) 808 can generate pixel data for output images in response to rendering commands (e.g., rendering commands from the CPU(s) 806 received via a host interface). The GPU(s) 808 can include graphics memory, such as display memory, for storing pixel data or any other suitable data, such as GPGPU data. The display memory can be included as part of the memory 804. The GPU(s) 808 can include two or more GPUs operating in parallel (e.g., via a link). The link can directly connect the GPUs (e.g., using NVLINK) or can connect the GPUs through a switch (e.g., using NVSwitch). When combined together, each GPU 808 can generate pixel data or GPGPU data for different portions of an output or for different outputs (e.g., a first GPU for a first image and a second GPU for a second image). Each GPU can include its own memory or can share memory with other GPUs.

In addition to or alternatively from the CPU(s) 806 and/or the GPU(s) 808, the logic unit(s) 820 can be configured to execute at least some of the computer-readable instructions to control one or more components of the computing device 800 to perform one or more of the methods and/or processes described herein. In embodiments, the CPU(s) 806, the GPU(s) 808, and/or the logic unit(s) 820 can discretely or jointly perform any combination of the methods, processes and/or portions thereof. One or more of the logic units 820 can be part of and/or integrated in one or more of the CPU(s) 806 and/or the GPU(s) 808 and/or one or more of the logic units 820 can be discrete components or otherwise external to the CPU(s) 806 and/or the GPU(s) 808. In embodiments, one or more of the logic units 820 can be a coprocessor of one or more of the CPU(s) 806 and/or one or more of the GPU(s) 808.

Examples of the logic unit(s) 820 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which can include one or more direct memory access (DMA) systems, one or more vision or vector processing units (VPUs), one or more pixel processing engines (PPEs), one or more decoupled accelerators (e.g., decoupled lookup table (DLUT) accelerators), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 810 can include one or more receivers, transmitters, and/or transceivers that allow the computing device 800 to communicate with other computing devices via an electronic communication network, i included wired and/or wireless communications. The communication interface 810 can include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 820 and/or communication interface 810 can include one or more data processing units (DPUs) to transmit data received over a network and/or through interconnect system 802 directly to (e.g., a memory of) one or more GPU(s) 808.

The I/O ports 812 can allow the computing device 800 to be logically coupled to other devices including the I/O components 814, the presentation component(s) 818, and/or other components, some of which can be built in to (e.g., integrated in) the computing device 800. Illustrative I/O components 814 include a microphone, mouse, keyboard, joystick, game pad, game controller, satellite dish, scanner, printer, wireless device, etc. The I/O components 814 can provide a natural user interface (NUI) that processes air gestures, voice, or other physiological inputs generated by a user. In some instances, inputs can be transmitted to an appropriate network element for further processing. An NUI can implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 800. The computing device 800 can be include depth cameras, such as stereoscopic camera systems, infrared camera systems, RGB camera systems, touchscreen technology, and combinations of these, for gesture detection and recognition. Additionally, the computing device 800 can include accelerometers or gyroscopes (e.g., as part of an inertia measurement unit (IMU)) that allow detection of motion. In some examples, the output of the accelerometers or gyroscopes can be used by the computing device 800 to render immersive augmented reality or virtual reality.

The power supply 816 can include a hard-wired power supply, a battery power supply, or a combination thereof. The power supply 816 can provide power to the computing device 800 to allow the components of the computing device 800 to operate.

The presentation component(s) 818 can include a display (e.g., a monitor, a touch screen, a television screen, a heads-up-display (HUD), other display types, or a combination thereof), speakers, and/or other presentation components. The presentation component(s) 818 can receive data from other components (e.g., the GPU(s) 808, the CPU(s) 806, DPUs, etc.), and output the data (e.g., as an image, video, sound, etc.).

### Example Data Center

FIG. 9 illustrates an example data center 900 that can be used in at least one embodiments of the present disclosure. The data center 900 can include a data center infrastructure layer 910, a framework layer 920, a software layer 930, and/or an application layer 940. The data center 900 can be used to implement some and/or all of the operations described with respect to the environment 100 of FIG. 1, the model architecture 200 of FIGS. 2A and 2B, etc.

As shown in FIG. 9, the data center infrastructure layer 910 can include a resource orchestrator 912, grouped computing resources 914, and node computing resources (“node C.R.s”) 916(1)-916(N), where “N” represents any whole, positive integer. In at least one embodiment, node C.R.s 916(1)-916(N) can include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 916(1)-916(N) can correspond to a server having one or more of the above-mentioned computing resources. In addition, in some embodiments, the node C.R.s 916(1)-9161(N) can include one or more virtual components, such as vGPUs, vCPUs, and/or the like, and/or one or more of the node C.R.s 916(1)-916(N) can correspond to a virtual machine (VM).

In at least one embodiment, grouped computing resources 914 can include separate groupings of node C.R.s 916 housed within one or more racks (not shown), or many racks housed in data centers at various geographical locations (also not shown). Separate groupings of node C.R.s 916 within grouped computing resources 914 can include grouped compute, network, memory or storage resources that can be configured or allocated to support one or more workloads. In at least one embodiment, several node C.R.s 916 including CPUs, GPUs, DPUs, and/or other processors can be grouped within one or more racks to provide compute resources to support one or more workloads. The one or more racks can also include any number of power modules, cooling modules, and/or network switches, in any combination.

The resource orchestrator 912 can configure or otherwise control one or more node C.R.s 916(1)-916(N) and/or grouped computing resources 914. In at least one embodiment, resource orchestrator 912 can include a software design infrastructure (SDI) management entity for the data center 900. The resource orchestrator 912 can include hardware, software, or some combination thereof.

In at least one embodiment, as shown in FIG. 9, framework layer 920 can include a job scheduler 928, a configuration manager 934, a resource manager 936, and/or a distributed file system 938. The framework layer 920 can include a framework to support software 932 of software layer 930 and/or one or more application(s) 942 of application layer 940. The software 932 or application(s) 942 can respectively include web-based service software or applications, such as those provided by Amazon Web Services, Google Cloud and Microsoft Azure. The framework layer 920 can be, but is not limited to, a type of free and open-source software web application framework such as Apache Spark™ (hereinafter “Spark”) that can use distributed file system 938 for large-scale data processing (e.g., “big data”). In at least one embodiment, job scheduler 928 can include a Spark driver to facilitate scheduling of workloads supported by various layers of data center 900. The configuration manager 934 can be capable of configuring different layers such as software layer 930 and framework layer 920 including Spark and distributed file system 938 for supporting large-scale data processing. The resource manager 936 can be capable of managing clustered or grouped computing resources mapped to or allocated for support of distributed file system 938 and job scheduler 928. In at least one embodiment, clustered or grouped computing resources can include grouped computing resource 914 at data center infrastructure layer 910. The resource manager 936 can coordinate with resource orchestrator 912 to manage these mapped or allocated computing resources.

In at least one embodiment, software 932 included in software layer 930 can include software used by at least portions of node C.R.s 916(1)-916(N), grouped computing resources 914, and/or distributed file system 938 of framework layer 920. One or more types of software can include, but are not limited to, Internet web page search software, e-mail virus scan software, database software, and streaming video content software.

In at least one embodiment, application(s) 942 included in application layer 940 can include one or more types of applications used by at least portions of node C.R.s 916(1)-916(N), grouped computing resources 914, and/or distributed file system 938 of framework layer 920. One or more types of applications can include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 934, resource manager 936, and resource orchestrator 912 can implement any number and type of self-modifying actions based on any amount and type of data acquired in any technically feasible fashion. Self-modifying actions can relieve a data center operator of data center 900 from making possibly bad configuration decisions and possibly avoiding underutilized and/or poor performing portions of a data center.

The data center 900 can include tools, services, software or other resources to train one or more machine learning models or predict or infer information using one or more machine learning models according to one or more embodiments described herein. For example, a machine learning model(s) can be trained by calculating weight parameters according to a neural network architecture using software and/or computing resources described above with respect to the data center 900. In at least one embodiment, trained or deployed machine learning models corresponding to one or more neural networks can be used to infer or predict information using resources described above with respect to the data center 900 by using weight parameters calculated through one or more training techniques, such as but not limited to those described herein.

In at least one embodiment, the data center 900 can use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above can be configured as a service to allow users to train or performing inferencing of information, such as image recognition, speech recognition, or other artificial intelligence services.

### Example Network Environments

Network environments suitable for use in implementing embodiments of the disclosure can include one or more client devices, servers, network attached storage (NAS), other backend devices, and/or other device types. The client devices, servers, and/or other device types (e.g., each device) can be implemented on one or more instances of the computing device(s) 800 of FIG. 8—e.g., each device can include similar components, features, and/or functionality of the computing device(s) 800. In addition, where backend devices (e.g., servers, NAS, etc.) are implemented, the backend devices can be included as part of a data center 900, an example of which is described in more detail herein with respect to FIG. 9.

Components of a network environment can communicate with each other via a network(s), which can be wired, wireless, or both. The network can include multiple networks, or a network of networks. By way of example, the network can include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) can provide wireless connectivity.

Compatible network environments can include one or more peer-to-peer network environments—in which case a server can not be included in a network environment- and one or more client-server network environments—in which case one or more servers can be included in a network environment. In peer-to-peer network environments, functionality described herein with respect to a server(s) can be implemented on any number of client devices.

In at least one embodiment, a network environment can include one or more cloud-based network environments, a distributed computing environment, a combination thereof, etc. A cloud-based network environment can include a framework layer, a job scheduler, a resource manager, and a distributed file system implemented on one or more of servers, which can include one or more core network servers and/or edge servers. A framework layer can include a framework to support software of a software layer and/or one or more application(s) of an application layer. The software or application(s) can respectively include web-based service software or applications. In embodiments, one or more of the client devices can use the web-based service software or applications (e.g., by accessing the service software and/or applications via one or more application programming interfaces (APIs)). The framework layer can be, but is not limited to, a type of free and open-source software web application framework such as that can use a distributed file system for large-scale data processing (e.g., “big data”).

A cloud-based network environment can provide cloud computing and/or cloud storage that carries out any combination of computing and/or data storage functions described herein (or one or more portions thereof). Any of these various functions can be distributed over multiple locations from central or core servers (e.g., of one or more data centers that can be distributed across a state, a region, a country, the globe, etc.). If a connection to a user (e.g., a client device) is relatively close to an edge server(s), a core server(s) can designate at least a portion of the functionality to the edge server(s). A cloud-based network environment can be private (e.g., limited to a single organization), can be public (e.g., available to many organizations), and/or a combination thereof (e.g., a hybrid cloud environment).

The client device(s) can include at least some of the components, features, and functionality of the example computing device(s) 800 described herein with respect to FIG. 8. By way of example and not limitation, a client device can be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure can be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure can be practiced in a variety of system configurations, including hand-held devices, consumer electronics, general-purpose computers, more specialty computing devices, etc. The disclosure can also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” can include only element A, only element B, only element C, element A and element B, element A and element C, element B and element C, or elements A, B, and C. In addition, “at least one of element A or element B” can include at least one of element A, at least one of element B, or at least one of element A and at least one of element B. Further, “at least one of element A and element B” can include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

What is claimed is:

1. One or more processors comprising:
one or more circuits to:
obtain image data for a current image being generated, in accordance with one or more light transport simulation operations;
execute one or more attention operations to determine an update to the current image based at least on a plurality of patches of the current image and windowed attention regions corresponding to at least one patch of the plurality of patches, the windowed attention regions extending at least in part beyond boundaries of each of the at least one patch; and
provide updated image data according to the update, to generate the current image.

2. The one or more processors of claim 1, wherein the one or more circuits are to:
determine a configuration for the windowed attention regions that, for each of the at least one patch, identifies tokens of the patch and one or more adjacent patches, and
wherein, to execute the one or more attention operations, the one or more circuits are to,
for each of the at least one patch, execute the one or more attention operations based at least on the tokens.

3. The one or more processors of claim 2, wherein, to determine the configuration for the windowed attention regions, the one or more circuits are to:
determine sub-regions for the windowed attention regions that extend across at least one horizontally adjacent patch or at least one vertically adjacent patch.

4. The one or more processors of claim 3, wherein, to determine the configuration for the windowed attention regions, the one or more circuits are to:
forgo determining sub-regions for the windowed attention regions that extend across at least one diagonally adjacent patch.

5. The one or more processors of claim 2, wherein the one or more circuits are to:
determine an offset to the windowed attention region for each of the at least one patch, the offset indicating a vertical offset or a horizontal offset of the windowed attention region relative to each of the at least one patch, and
wherein, to execute one or more attention operations, the one or more circuits are to:
apply the offset to the windowed attention region for each of the at least one patch, and
execute the one or more attention operations based at least on applying the offset.

6. The one or more processors of claim 1, wherein the plurality of patches of the current image comprises a first plurality of patches, and
wherein, to execute the one or more attention operations, the one or more circuits are to:
execute a first transformer along a contraction path of an attention-based model based at least on first patch embeddings for the first plurality of patches to generate updated first patch embeddings,
merge the updated first patch embeddings to form second patch embeddings; and
execute a second transformer along the contraction path based at least on the second patch embeddings.

7. The one or more processors of claim 6, wherein, to execute the first transformer along the contraction path, the one or more circuits are to:
determine at least one first threshold value associated with the execution of the one or more attention operations; and
generate the updated first patch embeddings based at least on the at least one first threshold value.

8. The one or more processors of claim 6, wherein, to execute the one or more attention operations, the one or more circuits are to:
execute a first transformer along an expansion path of the attention-based model based at least on the second patch embeddings to generate updated second patch embeddings;
expand the updated second patch embeddings to form third patch embeddings; and
execute a second transformer along the expansion path based at least on the third patch embeddings.

9. The one or more processors of claim 8, wherein, to execute the first transformer along the expansion path, the one or more circuits are to:
determine at least one second threshold value associated with the execution of the one or more attention operations; and
generate the updated first patch embeddings based at least on the at least one second threshold value.

10. The one or more processors of claim 8, wherein, to execute the first transformer and the second transformer along the contraction path, the one or more circuits are to:
execute the first transformer based at least on a first windowed attention region and a first offset, and
execute the second transformer based at least on a second windowed attention region and a second offset.

11. The one or more processors of claim 8, wherein, to execute the first transformer and the second transformer along the expansion path, the one or more circuits are to:
execute the first transformer based at least on a first windowed attention region and a first offset, and
execute the second transformer based at least on a second windowed attention region and a second offset.

12. The one or more processors of claim 1, wherein the one or more processors are comprised in at least one of:
a control system for an autonomous or semi-autonomous machine;
a perception system for an autonomous or semi-autonomous machine;
a system implemented using a robot;
an aerial system;
a medical system;
a boating system;
a smart area monitoring system;
a system for performing deep learning operations;
a system for performing simulation operations;
a system for generating or presenting virtual reality (VR) content, augmented reality (AR) content, or mixed reality (MR) content;
a system for performing digital twin operations;
a system implemented using an edge device;
a system incorporating one or more virtual machines (VMs);
a system for generating synthetic data;
a system implemented at least partially in a data center;
a system for performing conversational artificial intelligence (AI) operations;
a system for performing generative AI operations;
a system implementing language models;
a system for performing generative AI operations;
a system for implementing vision language models (VLMs);
a system for implementing large language models (LLMs);
a system for implementing small language models (SLMs);
a system for hosting one or more real-time streaming applications;
a system for performing light transport simulation;
a system for performing collaborative content creation for 3D assets;
a system using or deploying one or more inference microservices;
a system that incorporates one or more machine learning models deployed in a service or microservice along with an OS-level virtualization package (e.g., a container); or
a system implemented at least partially using cloud computing resources.

13. A system comprising:
one or more processors to perform operations comprising:
obtaining image data for a current image being generated, in accordance with one or more light transport simulation operations;
executing one or more attention operations to determine an update to the current image based at least on a plurality of patches of the current image and windowed attention regions corresponding to at least one patch of the plurality of patches, the windowed attention regions extending at least in part beyond boundaries of each of the at least one patch; and
providing updated image data according to the update, to generate the current image.

14. The system of claim 13, wherein the one or more processors are to perform the operation of:
determining a configuration for the windowed attention regions that, for each of the at least one patch, identifies tokens of the patch and one or more adjacent patches, and
wherein, to execute the one or more attention operations, the one or more processors are to,
for each of the at least one patch, execute the one or more attention operations based at least on the tokens.

15. The system of claim 14, wherein the one or more processors that perform the operation of determining the configuration for the windowed attention regions are to perform the operation of:
determining sub-regions for the windowed attention regions that extend across at least one horizontally adjacent patch or at least one vertically adjacent patch.

16. The system of claim 15, wherein the one or more processors that perform the operation of determining the configuration for the windowed attention regions are to:
forgo determining sub-regions for the windowed attention regions that extend across at least one diagonally adjacent patch.

17. The system of claim 14, wherein the one or more processors are to perform the operation of:
determining an offset to the windowed attention region for each of the at least one patch, the offset indicating a vertical offset or a horizontal offset of the windowed attention region relative to each of the at least one patch, and
wherein the one or more processors that perform the operation of executing one or more attention operations are to perform the operation of:
applying the offset to the windowed attention region for each of the at least one patch, and
executing the one or more attention operations based at least on applying the offset.

18. The system of claim 13, wherein the plurality of patches of the current image comprises a first plurality of patches, and
wherein the one or more processors that perform the operation of executing the one or more attention operations are to perform the operation of:
executing a first transformer along a contraction path of an attention-based model based at least on first patch embeddings for the first plurality of patches to generate updated first patch embeddings,
merging the updated first patch embeddings to form second patch embeddings; and
executing a second transformer along the contraction path based at least on the second patch embeddings.

19. The system of claim 18, wherein the one or more processors that perform the operation of executing the one or more attention operations are to perform the operation of:
executing a first transformer along an expansion path of the attention-based model based at least on the second patch embeddings to generate updated second patch embeddings;
expanding the updated second patch embeddings to form third patch embeddings; and
executing a second transformer along the expansion path based at least on the third patch embeddings.

20. The system of claim 13, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more vision language models (VLMs);
a system implementing one or more small language models (SLMs);
a system for generating synthetic data;
a system for generating synthetic data using AI;
a system incorporating one or more virtual machines (VMs);
a system implemented at least partially in a data center;
a system using or deploying one or more inference microservices;
a system that incorporates one or more machine learning models deployed in a service or microservice along with an OS-level virtualization package (e.g., a container); or
a system implemented at least partially using cloud computing resources.

21. A method comprising:
obtaining image data for a current image being generated, in accordance with one or more light transport simulation operations;
executing one or more attention operations to determine an update to the current image based at least on a plurality of patches of the current image and windowed attention regions corresponding to at least one patch of the plurality of patches, the windowed attention regions extending at least in part beyond boundaries of each of the at least one patch; and
providing updated image data according to the update, to generate the current image.

22. The method of claim 21, wherein the method is performed by at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system implemented at least partially in a data center;
a system using or deploying one or more inference microservices;
a system that incorporates one or more machine learning models deployed in a service or microservice along with an OS-level virtualization package (e.g., a container); or
a system implemented at least partially using cloud computing resources.
